(19) United States
(12) Patent Application Publication
(10) Pub. No.: US 2014/0324455 A1
(43) Pub. Date: Oct. 30, 2014

(54) CENTRAL CONTROL OF DISTRIBUTED ORGANIZATIONAL STRUCTURES

(71) Applicant: CYTOLON AG, Berlin (DE)

(72) Inventors: Andreas Schimanski, Berlin (DE); Ralf Schliehe-Diecks, Berlin (DE); Thomas Klein, Potsdam (DE)

(21) Appl. No.: 14/359,103

(22) PCT Filed: Nov. 19, 2012
(86) PCT No.: PCT/EP2012/072991

§ 371 Date: May 18, 2014

Related U.S. Application Data
(60) Provisional application No. 61/561,398, filed on Nov. 18, 2011.

(30) Foreign Application Priority Data
Nov. 18, 2011 (EP) 11075252.4
Nov. 18, 2011 (EP) 11075253.2

(51) Int. Cl. G06F 19/00; G06F 17/30

(52) U.S. Cl. CPC G06F 19/327; G06F 17/30864
USPC 705/2

(57) ABSTRACT

The invention relates to a control system for distributed organizational structures, comprising one or more organizations with one or more organizational units; users are assigned to at least one organization; and roles are assigned to the users, and the roles determine the available functionalities within the organization that is assigned to the user. The invention also relates to the use of the control system for identifying inventories from locally available database systems and remote database systems, preferably umbilical cord blood data.

### PRIOR ART

In the prior art, there are known databases and organizational structures that can be used to process search queries of inventories. In the medical and pharmaceutical fields, these are mostly queries regarding particular medications or for example transplants. Consequently it is as a rule a sales process that is initiated by a search query according to certain criteria. The disadvantage with the prior art is that it does not support the structure of organizations (for example a registry). Consequently, only limited options are available.

Individual users sometimes work for two hospitals, for example, or for an umbilical cord blood database and a hospital. Previously, it was not possible to permit these users to access this organizational structure with only one account.

Since increasing numbers of hospitals are combining to form networks or also, hospitals are cooperating with certain institutions, it is disadvantageous to strictly assign a user to only one individual hospital or institution.

New technical data structures are required in order to support the complex organizational structures. The problem underlying the invention, therefore, is that a control system must be created, which does not have the disadvantages of the prior art and is able to support distributed organizational structures primarily with regard to the administration of umbilical cord blood data.

### DESCRIPTION

The object is attained by means of the independent claims. Advantageous embodiments are disclosed in the dependent claims.

In a first preferred embodiment, the invention relates to a control system for distributed organizational structures, comprising

at least one organization with at least one organizational unit,
wherein the organizational unit has technical attributes and
the organizational units can be providers and/or inquiring parties;
at least two users,
wherein the users are assigned to at least one organization; and
at least one role,
wherein the role is assigned to at least one user and
the role determines the available functionalities within the organization that is assigned to the user,
the organization to which a user is assigned determines the view that is shown to the user and
a first user can create a search request, which is sent to organizations that include provider organizational units and
the user can then send a request to an organization and
another user that is assigned to the organization to which the request has been made processes the request.

One advantage of the invention is that the control system can be used for many different application areas and platform participants and directly supports more complex organizational structures such as registries. The control advantageously system makes it advantageously possible to control a multitude of connected organizational units.

Preferably, the organizational unit is selected from a group including network, hospital, institution, and/or administration. In this case, the organizational unit can preferably adopt various technical characteristics:

1. Network (aka groups or group)
2. Hospital (aka clinic)
3. Institution (aka facility)
4. Administration (aka back office)

A network is preferably a network of at least two hospitals, a network of at least two institutions, or a network of at least one hospital and at least one institution.

A particularly preferable embodiment is a network of umbilical cord blood banks and/or umbilical cord blood databases. A network of one or more hospital(s) and one or more umbilical cord blood bank(s) is preferable.

The invention does not provide that a network includes another network. It also does not provide that a hospital includes other hospitals or that an umbilical cord blood database includes other umbilical cord blood databases. In addition, an umbilical cord blood database may contain no network.

An organization can correspond to an organizational unit, for example if the organizational unit is an independent hospital. In such a case, the hospital is the organizational unit and the organization at the same time.

The prior art uses only domain models that provide a systematic separation of the query side and the database side. This is disadvantageous since it is becoming more and more usual on the one hand, for various institutions to combine, but also for institutions to combine, for example, with hospitals so that in the networks, the classic inquiring party side merges with the database side.

Consequently, an organizational unit can also contain other organizational units (for example a network includes a hospital). It is not possible, however, for a hospital to contain a network. Preferably, only a network can contain other organizational units.

It is preferable that an institution is selected from the group including an umbilical cord blood bank, an umbilical cord blood database, a blood bank, a stem cell bank, a donor registry, a tissue bank, and/or an organ bank.

It is also preferable for a hospital to include one or more subsidiary hospitals.

Users are assigned to the specific organizational unit (for example a hospital). One advantage of the invention is that via the network, users can also be assigned to a plurality of hospitals and/or umbilical cord blood databases. The invention permits these users a central access to the organization with only one account. It is preferable that a user who has been assigned to a network cannot be assigned to hospitals/umbilical cord blood databases outside the network.

Another advantage of the invention is also the fact that the platform and/or the system support(s) users regardless of the organization. In other words, it is no longer necessary, as in the prior art, for there to be specific “search center users” and “provider users.” Consequently, the users are permitted access to various organizational units if the users have been assigned to the organization to which these organizational units belong

In this case, a user is assigned to the organization or organizational units for which he is responsible or for which he works. In this connection, there can be restrictions so that a user can also be assigned only to particular organizational units within a network. The assignment to a network therefore does not result in the assignment to all of the organizational units that belong to the network; this must occur explicitly. As a result, an additional protection is built in, which is advantageous since the field of personalized medicine sometimes involves very sensitive data that not every user should be automatically permitted to see.

The assignment to the back office is likewise exclusive, which is already assured by the fact that the back office is its own organizational unit, which is preferably not combined with any other organizational units.

The user receives an account with which he can access the organizations or organizational units to which he has been assigned.

Preferably, a user is assigned to a network, a hospital, an institution, or a back office.

In this connection, the user cannot simultaneously be assigned to a network and to independent organizational units.

According to the invention, the available functions within the organizations and organizational units are defined by means of a role concept. In other words, the assignment defines only the access to the corresponding organizational units, but not which specific data can be accessed and which processing functions can be performed. This is important in order to permit data protection and to ensure a coordinated sequence of queries and responses to them.

The role is preferably selected from the group including administrator, manager, supervisor, and coordinator.

A user is assigned roles that define the available functionality within the organizational unit(s) to which the user is assigned. The roles in this case are preferably hierarchically arranged; in other words, a role always includes the rights of the roles of a lower level.

Preferably, there are the following role levels, the 1^{st} level being the highest:

### 1. Administrator

### 2. Manager

### 3. Supervisor

### 4. Coordinator

For example, the role of the manager has the functionality of accepting approval processes.

The role of the supervisor permits access to all data of the assigned organizational units as well as the right to read, write, and/or delete them.

The role of coordinator permits access to the data belonging to the assigned organizational units as well as the right to read, write, and/or delete them.

A higher level always includes the functionalities of the levels below it.

For an umbilical cord blood database user, for example, the following roles and functions are available:

1.1 Hospital administrator (includes all the rights of role 2.1)

The hospital administrator has access to
Administration of hospital users
Reassigning patients
   1.2 Umbilical cord blood database administrator (includes all the rights of role 2.2)
Administration of umbilical cord blood database users
   1.3 Back office administrator
Everything throughout the system
   1.4 Back office agent

The access rights of the back office agent are restricted by comparison with the back office administrator. The back office agent cannot manage patient data and umbilical cord blood units or the data relating to them.

2.1 Hospital manager (includes all rights of role 3.1)

The role of hospital manager permits approval of queries and requests that require acceptance.

2.2 Umbilical cord blood database manager (includes all rights of role 3.2)

The role of umbilical cord blood database manager permits approval of queries and requests that require acceptance.

3.1 Hospital supervisor (includes all rights of role 4.1)

The hospital supervisor has access—for assigned hospitals—to patient data, messages, physician data, search profiles, and hospital data

3.2 Umbilical cord blood database supervisor (includes all rights of role 4.2)

The umbilical cord blood database supervisor has access—for assigned umbilical cord blood databases—to data about umbilical cord blood units (CBUs) and to data about umbilical cord blood databases

4.1 Hospital coordinator

The role of the hospital coordinator permits access—for assigned hospitals—to his own patient data, in particular patient data that he himself has created, and to messages relating to these patients.

4.2 Umbilical cord blood database coordinator

The role of the umbilical cord blood database coordinator permits access to messages for assigned umbilical cord blood databases.

Thanks to the hierarchical role system, it is no longer necessary to assign a user an arbitrary number of roles. The roles depend on the organizational units to which the user is assigned. There are the following role assignments:

1. The user is assigned to hospital(s)+umbilical cord blood database(s) and is given a hospital role+umbilical cord blood database role
2. The user is assigned to hospital(s) and is given a hospital role
3. The user is assigned to umbilical cord blood database(s) and receives an umbilical cord blood database role
4. The user is assigned to the back office and is given a back office role

When a user is assigned to a network, then a simplified assignment to all of the organizational units of the network must be provided. This can be preferable since when the user is created, it is not necessary to carry out a large number of individual assignments, which would require a lot of work, especially with large networks.

Only back office users are authorized to create organizations and organizational units and to modify organizational structures. This is advantageous since the system is less susceptible to errors if only a limited group of users has these accesses and modification rights.

In other words, only back office users can create and delete hospitals, umbilical cord blood databases, and networks.

It is also preferable that the other user that is assigned to the organization to which the query has been submitted processes the query, namely approves it and as a result, a display showing that the query has been approved is shown to the user who submitted the query.

It is also preferable that the other user that is assigned to the organization to which the query has been submitted processes the query and activates an approval step.

According to the invention, the control system can also be used for other organizations in addition to a registry. For example, it can be advantageous for the structure, which includes a method, a system, and/or a device, to be used for pharmaceutical companies, governmental structures, medications, the distribution/administration of medications, or treatment methods and/or produces a connection between the physician, hospital, control instrument, and/or governmental authority in order, for example, to appropriately administer and or distribute medications or treatment methods. In this connection, the invention can in particular be referred to as a means for personalized medicine.

The invention will be explained below in the context of the administration of umbilical cord blood preparations, but the invention is not limited to them.

In actual practice, organizational structures of this kind are groupings of hospitals and/or umbilical cord blood databases, but in addition to this, it must also be possible to support independent umbilical cord blood databases as well as independent hospitals (previously mapped as research centers with a hospital).

Through a restructuring of the technical data, the invention permits the support of networks of registries, for example, consequently simplifying prior systems in the area of personalized medicine.

The platform, preferably the umbilical cord blood data platform, supports the creation of networks (for example a registry) of hospitals and/or umbilical cord blood banks (umbilical cord blood databases) as an organizational unit. As a result, the users are provided with new and improved options for searching for data or for querying inventories.

It is also preferable for independent hospitals and independent institutions to be supported as organizational units. In other words, preferably, there can still also be hospitals or institutions that are not assigned to any network. Only those hospitals that have no subsidiary hospitals are identified as independent hospitals.

It is particularly preferable that the system and/or the platform continues to support independent umbilical cord blood banks and umbilical cord blood databases as organizational units, i.e. those umbilical cord blood databases that are not assigned to any network. An independent umbilical cord blood database cannot include other umbilical cord blood databases.

One advantage of the invention is the flexibility of the system, which makes it possible to add additional organizational units to it at any time. For example, donor registries or tissue databases can be added as additional institutions and can therefore greatly expand the application range of the invention. These newly added institutions can likewise be part of a network.

On the one side there are thus the hospitals and/or networks with hospitals as “searchers” or “inquirers” and on the other side, there are institutions and/or networks with institutions, which offer inventories, preparations, and/or data. It is completely preferable in this context that an umbilical cord blood database is the institution and includes or offers these umbilical cord blood units as preparations.

According to the invention, the organizational units have technical attributes. In this connection some attributes are ones that all organizational units possess. These attributes include: name, description, address, contact person, billing address, contact person billing, and logo.

It is preferable for a network to have no other attributes. It is also preferable for a hospital and an institution to have an identification (ID) as an additional attribute. Furthermore, it is preferable for umbilical cord blood databases to also have an accreditation in addition to an identification.

It is preferable for the attribute “default language” to no longer be an attribute of the organizational units. In the system and/or platform of the invention, the default language is defined for the specific user. This prevents the occurrence of conflicts when a user is assigned to different organizational units.

The following attributes may also be used: “standard duration for reservations” and “number of reservations.”

It is preferable for the available views to handle the above-described new technical data structure. In this connection, preferably the following views are supported:

1. Groups view (for networks that include hospitals and institutions, preferably umbilical cord blood databases)
2. Hospitals view (for networks of hospitals or for independent hospitals)
3. Umbilical cord blood databases view (for networks of umbilical cord blood databases or independent umbilical cord blood databases)
4. Back office view (for administration of the system)

The user is then shown the respective view as a function of his assignment to organizational units or organizations. The functionalities that are available in a view are in turn dependent on his user roles.

The views available to the user as well as their design (for example secondary overviews) are thus a function of the organizations and organizational units to which the user is assigned and their configuration (for example the network contains only hospitals).

The visibility of the functionalities (and of the menu items that enable the access) depends on the assignment of the user to the organizations or organizational units and on his roles.

This yields the following cases:

1. A user is assigned to one or more hospitals. The user sees only the hospitals view.
2. A user is assigned to one or more umbilical cord blood databases. The user therefore sees only the umbilical cord blood databases view.
3. A user is assigned to one or more hospitals and one or more umbilical cord blood databases. The user sees the groups view, which provides access to the hospital view and the umbilical cord blood databases view.

In this case, the top-level menu item is not respectively shown. In other words, the “groups view” and the “back office view” are never shown as menu items. The “hospitals view” and “umbilical cord blood databases view” are only shown if a network contains hospital(s) and umbilical cord blood database(s).

For the functionalities of a network that contains hospitals and institutions, preferably umbilical cord blood databases, it is necessary for there to be a component or view that provides access to the following views:

1. Hospitals view
2. Umbilical cord blood databases view
3. Users overview

### 4. Preferences

### Hospitals View:

For the functionalities of a hospital or several hospitals of a network, what was needed was a component or view that enabled and/or provided the following functionalities:

1. Patients—Access to the “patients overview”: Includes patient data of an independent hospital or of all hospitals of the network
2. Messages—Access to the “hospital messages overview”: Includes messages of an independent hospital or of all hospitals of the network. In the context of the invention, the German term “Nachrichten” is used to mean the same thing as the English term “messages.”
3. Hospitals—Access to the “hospitals overview”: Includes the data of an independent hospital and/or of all hospitals of the network
4. Users—Access to the “users overview”: Includes user data of an independent hospital and/or of all hospitals of a network. This view is only visible if the network contains only hospitals; otherwise, the component is the network view.
5. Preferences—Access to the preferences of the currently logged-in user. This view is only visible if the network contains only hospitals; otherwise, the component is the “groups view.”

In this connection, the data (patients, messages, hospitals) shown in the accessible overviews are restricted by the assignment of the user to one or more hospitals and by the role of the user. It is thus possible to determine very individually which data a user can access and edit.

For the functionalities of an umbilical cord blood database or a plurality of umbilical cord blood databases of a network, a component or view is required, which makes accessible or provides the following functionalities:

1. Messages—Access to the “umbilical cord blood database messages overview”: Includes messages of an independent umbilical cord blood database or of all umbilical cord blood databases of the network.
2. Umbilical cord blood units (CBU) management—Access to “CBU overview”: Includes CBUs of an independent umbilical cord blood database or of all umbilical cord blood databases of the network.
3. Umbilical cord blood databases—Access to the “umbilical cord blood databases overview”: Includes an independent umbilical cord blood database or all umbilical cord blood databases of the network.
4. Users—Access to the “users overview”: Includes user data of an independent umbilical cord blood database or of all umbilical cord blood databases of a network. This view is only visible if the network contains only umbilical cord blood databases; otherwise, this component is the network view.
5. Preferences—Access to the preferences of the currently logged-in user; this view is only visible if the network contains only umbilical cord blood databases; otherwise, the component is the “groups view.”

Here, too, the data shown in the accessible overviews (messages, CBUs, umbilical cord blood databases) are restricted by the assignment of the user to one or more umbilical cord blood databases and by the role of the user.

### Back Office View:

For the functionalities of the back office, a component or view was required, which makes accessible or provides the following functionalities:

1. Messages—Access to the “back office messages overview”
2. Organizations—Access to the “organizations view”: includes all organizations and organizational units (for example networks, independent hospitals, and independent umbilical cord blood databases)
3. Users—Access to “users overview”

### 4. Preferences

The organizations overview is only accessible for back office users and displays in tabular form all organizations that have been created in the platform and/or system and also offers the functionality of creating all available organizations and organizational units and their users as well as associated data (see FIG. 3).

The organizations overview in this case is hierarchically arranged in accordance with the structures that are available in the platform and/or the system. In other words, on the top level, for example only independent hospitals, umbilical cord blood databases, and networks are visible. In addition, the create function is restricted to only these organization types. To edit the structure of a network, it is necessary to correspondingly navigate one level down. Here, it is then possible to create and edit the units and users of the network.

Consequently, the organizations view directly maps the available technical structure of the organizations.

### Organizations Overview

The organizations overview shows in tabular and hierarchical form the organizations as well as their data and permits access to the following functions:

1. Data shown

Identification, name, type (hospital, umbilical cord blood database, groups), country

2. Access to functionalities

### 2.1 (General)

Create hospital (creating independent hospitals)
Create umbilical cord blood database (creating independent umbilical cord blood databases)
Create groups (creating groups (networks))
   2.2 (per organization—via the “manage” column of the table)
Edit (“master data”)
Users (access to “users overview”)
Hospitals [only with the “groups” type] (access to the “hospitals view”)
Umbilical cord blood databases [only with the “groups” type] (access to the “umbilical cord blood database overview”)
CBU [only with the “umbilical cord blood database” type] (access to the prior functionality)
Physicians [only with the “hospital” type] (access to the prior functionality)
Search profiles [only with the “hospital” type] (access to the prior functionality)

In the organizations overview, therefore, only independent hospitals, umbilical cord blood databases, and networks (groups) are shown. In order to carry out further structuring of a network, one navigates to the specific network and once there, accesses the “hospitals overview” and the “umbilical cord blood databases overview.” Once there, it is then possible to create them in the direct context of the network and their assignment therefore also takes place in an implicit fashion.

The back office does in fact also technically constitute an organizational unit, but it represents a special organizational unit that does not possess any properties or the like. The creation of users for the back office occurs through direct access via the back office view.

In the hospitals overview, it is advantageously possible to show hospitals and the data associated with a hospital. In this case, it is not important whether it is an independent hospital, a hospital in an “exclusively hospitals” network, or a hospital in a “mixed” network. The hospitals overview always shows the corresponding hospital(s) in tabular form. Only in the case of a back office user is it also necessary to provide the functionality of creating a hospital for the corresponding network from which one has navigated into the hospitals overview.

The hospitals overview shows the hospitals and their data in tabular, context-sensitive form and permits access to the following functions:

1. Displayed data

Identification, name, city, contact person

2. Access to functionalities

Edit (“master data”), physicians, search profiles, and create hospital (only visible in back office).

3. Context-sensitive displays:
3.1 Access via the “organizations view” or “hospitals view”
Display of all hospitals of the corresponding network
   3.2 Access via the hospitals view (independent hospital)
Display of the specific hospital

The display of hospitals is also limited by the assignment of the user. In other words, the user only sees the hospitals to which he is assigned. A back office user is not subject to these restrictions.

The umbilical cord blood databases overview is in particular used to display umbilical cord blood databases and to edit the data associated with umbilical cord blood databases. In this case, it is not important whether they are independent umbilical cord blood databases, umbilical cord blood databases in networks made up of exclusively umbilical cord blood databases, or umbilical cord blood databases in mixed networks. The umbilical cord blood database overview always shows the corresponding umbilical cord blood database(s) in tabular form. Only in the case of a back office user is it necessary to provide the functionality of creating an umbilical cord blood database for the corresponding network from which one has navigated into the umbilical cord blood databases overview.

The umbilical cord blood database overview shows the umbilical cord blood databases and their data in tabular, context-sensitive form and permits access to the following functions:

1. Displayed data

Identification, name, country, contact person, phone number, email address

2. Access to functionalities

Edit (“master data”), “manage” CBU, create umbilical cord blood database (only visible in back office).

3. Context-sensitive displays:
3.1 Access via the “organizations view” or “umbilical cord blood databases view” (contains the network of the umbilical cord blood databases)
Display of all umbilical cord blood databases of the corresponding network
   3.2 Access via the umbilical cord blood databases view (independent umbilical cord blood database)
Display of the specific umbilical cord blood database

The display of umbilical cord blood databases is also limited by the assignment of the user. In other words, the user only sees the umbilical cord blood databases to which he is assigned. A back office user is not subject to these restrictions.

The users overview is used to display user data and to create and/or edit these data. The users view is also flexible and displayed in tabular form in accordance with the navigation path and/or organization to which the user is assigned.

The users overview shows the users and their data in tabular, context-sensitive form and permits access to the following functions:

1. Displayed data

Email address, last name, first name, role, assignments (to organization(s)), and last login

2. Access to functionalities

Edit (user), create (access to create/edit users view), show patients, reassign patients

3. Context-sensitive displays:
3.1 Access via the groups view (network with hospitals and umbilical cord blood databases)
Display of all users of the corresponding network
   3.2 Access via the hospitals view (network includes exclusively hospitals)
Display of all users of the hospitals of the network
   3.3 Access via the hospitals view (independent hospital)
Display of all users of the specific hospital
   3.4 Access via the umbilical cord blood databases view (network includes exclusively umbilical cord blood databases)
Display of all users of the umbilical cord blood databases of the network
   3.5 Access via the umbilical cord blood databases view (independent umbilical cord blood database)
Display of all users of the specific umbilical cord blood database
   3.6 Access via back office view
Display of all users of the back office

The access to the users view is permitted only to users with administrator roles and/or to back office users.

The system also includes a create/edit users view, which offers the following functionalities:

### Functionalities of the Previous Create/Edit Users View:

1. Display of the fields of user master data
2. Display of the user operations (currently: “default language” and “show deleted object”)

The invention has also added primarily the following functionalities:

1. Assignment of user roles
2. Assignment to specific organizations (in the case of a network)

In this case, the user is always created and implicitly assigned in the context in which the create function has been activated. In other words, in the context of an independent hospital, the user is automatically assigned to this hospital. In the context of a network, the assignment is to the network. The detailed assignment to organizations of the network is carried out as described above. In the context of the back office, the user is assigned to the back office.

The display of roles must be modified since there are no longer specific users (search center users/umbilical cord blood database users).

The roles are preferably displayed in grouped form:

Group 1—back office roles
Group 2—hospital roles
Group 3—umbilical cord blood database roles

In this case, only one role can be selected per group and the quantity of available roles depends on the assignment to organizational units. It is also preferable for the back office roles to be exclusive; in this case, a further assignment to hospital and/or umbilical cord blood database roles is not necessary.

### Assignment to Organizations of a Network:

If the user that has been/will be created is a “network user,” i.e. the user was created in the context of a network (groups), then it is possible in the create/edit users view to carry out the assignment to the organizations (hospital(s) and/or umbilical cord blood database(s)).

A view of the available organizations and the already performed assignments is required here. It is also possible to simultaneously assign a user to all available organizations of the network.

A “hospital administrator” and/or an “umbilical cord blood database administrator” who belongs to a network can advantageously assign users that he creates only to organizations to which he himself is assigned.

Furthermore, such an administrator cannot assign back office roles. This can only be done by back office administrators.

If a user's assignment to organizations of a type (for example umbilical cord blood databases) of a network (groups) is removed, then a robust behavior for handling the assigned roles (for example “umbilical cord blood database supervisor”) must be defined. It is preferable for the roles to be removed at the same time as this in order to prevent an unpredictable behavior. This makes the system more reliable and controllable.

The create and edit groups view is opened from the organizations overview and permits the display and editing of fields of the master data of a network (groups).

The patients overview shows all patient data in tabular, context-sensitive form.

1. All patients of an independent hospital
2. Patients of all hospitals of a network

In addition, the display of patients depends on a user's assignment to organizational units (hospitals) and on the user's role. In principle, a user can only see the patients of the hospitals to which he is assigned. In the case of a “hospital coordinator,” he is even restricted to only the patients that he himself has created.

The hospital to which a patient is assigned is shown in the “patients overview” (new column). This is necessary in order to be able to filter by the patients of a hospital.

When creating the patient, the user, depending on his assignment to a hospital or to several hospitals, must correspondingly have the option to select the hospital to which he wishes to assign the patient. Previously, the hospitals available for selection were always the hospitals of the search center to which the user was assigned.

If the user is assigned to only one hospital, then this is preselected immediately.

When creating CBUs, the user, depending on his assignment to an umbilical cord blood database or to several umbilical cord blood databases, has the option to select the umbilical cord blood database to which he wishes to assign the CBU. Previously, there was always one unique assignment here in the context of the umbilical cord blood database. Now, it is advantageously possible to assign it selectively.

Since there is the possibility of a user being assigned to various umbilical cord blood databases, it is necessary when importing to indicate via the interface the umbilical cord blood database ID for which the CBUs are to be imported. In the prior art, there was always one unique assignment in the context of the user, which is why this property is required for the first time by the invention. Choosing selectively makes it possible to optimize procedures and adapt to certain circumstances.

For reasons of downward compatibility for the previous umbilical cord blood databases, it is preferable to continue to permit imports to be made without inputting the umbilical cord blood database ID. Since the previous umbilical cord blood databases are always independent umbilical cord blood databases, in this case, the umbilical cord blood database ID can be determined by the platform. This is because the user is assigned to exactly one database.

Once the user is assigned to more than one database, then it is no longer possible to perform an import without indicating an umbilical cord blood database ID.

The umbilical cord blood database to which a CBU is assigned must be visible in the “CBU overview.” This is necessary in order to be able to filter by the CBUs of an umbilical cord blood database.

The hospital messages overview shows all messages in tabular, context-sensitive form.

1. All messages of an independent hospital
2. Messages of all hospitals of a network

Furthermore, the display of messages depends on a user's assignment to organizational units (hospitals) and on the user's role. In principle, a user can only see the messages of patients from the hospitals to which he is assigned. In the case of a “hospital coordinator,” he is even restricted to only the patients that he himself has created. A user preferably has access only to messages of patients to whose data he has access.

The hospital to which a message is assigned is shown in the “hospital messages overview.” This advantageously permits a filtering by messages of a hospital.

The umbilical cord blood database messages overview shows all messages in tabular, context-sensitive form.

1. All messages of an independent umbilical cord blood database
2. Messages of all umbilical cord blood databases of a network

Furthermore, the display of messages depends on a user's assignment to organizational units (umbilical cord blood databases). In principle, a user can only see the messages from the umbilical cord blood databases to which he is assigned.

The umbilical cord blood database to which a message is assigned is shown in the “umbilical cord blood database messages overview” (new column). This is necessary in order to be able to filter by the messages of an umbilical cord blood database.

Previously, it was possible in the “umbilical cord blood database messages overview” to access the data of the corresponding search center. Here, it must now be possible to access the hospital data.

The back office messages overview shows all messages in tabular, context-sensitive form.

The hospital, umbilical cord blood database, and network (if applicable) to which a user is assigned are visible in the “back office messages overview.” This is necessary in order to be able to appropriately filter the messages. Previously, “only” the search center and the umbilical cord blood database were specified.

For each hospital and umbilical cord blood database, it is possible for each request type to activate an approval step that comes after the creation of a request and before its transmission to the umbilical cord blood database.

On the umbilical cord blood database side, the approval must be carried out immediately after receipt of the request.

This requires an additional “manager” role, which has the authority to grant this approval. The context for this is the additional approval of fee-based requests, primarily by registry employees for associated hospitals and umbilical cord blood databases that issue or process fee-based requests.

The confirmation steps can only be carried out by users in a manager role.

Only users with the appropriate manager role “hospital manager” or “umbilical cord blood database manager” are permitted to issue a conformation for a request. It is necessary here to make sure that the user is assigned to the corresponding organizational unit. Only if the user is assigned to the corresponding hospital/umbilical cord blood database can he perform the confirmation steps for it.

As part of the acceptance process, the invention has added the following new request statuses:

1. Hospital side: “Waiting for approval”
2. Hospital side: “Refused”
3. Institution side (umbilical cord blood database): “Approved”

After a request is created, it is given the “Waiting for approval” status if a confirmation step is defined for the corresponding request type. After the confirmation by a user with the role of “hospital manager” (requests were previously created only on the hospital side), then in accordance with the request type, the status is moved one step further (for example “Requested”) and can then be seen on the umbilical cord blood database side.

On the umbilical cord blood database side, a user with the role of “umbilical cord blood database manager” must now in turn confirm this request, provided that a corresponding confirmation step has also been defined on the umbilical cord blood database side. If this has happened, then the request has the status “Approved” and handling can proceed.

On the hospital side, the user with the role “hospital manager” must have the option to refuse a request with a status of “Waiting for approval.” In this case, the request is then given the status “Refused.” When it has this status, the request is only visible on the hospital side.

Like the previous status values, the two new status values are displayed in the “request” overview.

The status value “Waiting for approval” in this case is only visible on the hospital side because the request only becomes visible on the umbilical cord blood database side after it has the status “Requested” (Reservation request “Reserved”). The status value “Approved” is visible on both the hospital side and the umbilical cord blood database side.

For each request type, it must be possible to configure whether a confirmation step by a user in a manager role is required or not. This relates to all request types that are available in the platform and/or system. Preferred request types are: reservation request, order request, HLA-typing request, sample request, colony assay request.

Only users with the following user roles can activate and edit the confirmation steps:

1. The hospital administrator can activate confirmation steps on the hospital level (only for assigned hospitals).
2. The umbilical cord blood database administrator can activate confirmation steps on the umbilical cord blood database level (only for assigned umbilical cord blood databases).
3. The back office user can activate confirmation steps on both of the hospital level and the umbilical cord blood database level.

It must be possible for a user in a manager role—on an individual basis for each hospital and umbilical cord blood database—to specify/edit the definition of which request types require a confirmation step.

According to the invention, an option to define confirmation-relevant request types must not be available at a network (groups) level.

In a standard situation, no confirmation steps for hospitals or umbilical cord blood databases are activated.

The status bar displays the new status as follows:

If the request has the status “Waiting for approval,” then the status “Creating” remains highlighted in the status bar.

If the request has the status “Approved,” then the status “Processing” is highlighted in the status bar.

If the request has the status “Refused,” then a new status bar is required, which contains the status “Creating” and the status “Refused” and in which the status “Refused” is highlighted.

If a reservation request has turned into an order request and a confirmation step is defined for the order request, then the reservation request must continue until the order request has been confirmed, i.e. switches from the status “Waiting for approval” to the status “Requested.”

The reservation request continues unchanged and expires when the order request has the status “Waiting for approval.” The user is then free to extend the reservation as usual.

The exact status transitions, status buttons (of request dialogs), status texts, confirmation texts, and status graphs are defined in the detailed request matrix.

As part of the approval concept, according to the invention, another level is provided for restricting the visibility of requests. The visibility of a request is additionally dependent on the assignment of the user to one or more organizations, the user's role, and the status of the request. According to the combination of these factors, the request is either visible or not in the request overview.

For example, if on the umbilical cord blood database side, a request has the status “Requested” and the approval process for this request type is activated, then this request is only visible for users with the role “hospital manager” (and higher).

New or changed requests can be marked. On the hospital side, a request must be marked as changed by a user in the context of a hospital role basically when the other side performs a modification and the user is the owner of the request.

An exception to this, for example, is when the status “Refused” is reached. Here, too, the user is informed, even though the modification has not been performed by the other side (the hospital manager has refused the request).

On the umbilical cord blood database side, requests are basically only marked for users with the role “umbilical cord blood database supervisor” and “umbilical cord blood database coordinator” if the requests are new or have been changed by the other side.

The only exception in this case is the status “Requested” in the case of an activated approval process. In this case, for users with the role “umbilical cord blood database manager,” the request is marked as new or as “to be confirmed” from a technical standpoint. A marking for users with the role “umbilical cord blood database coordinator” or “umbilical cord blood database supervisor” is not possible due to the requirement for restricted visibility.

Because of the approval process, the list of determinative factors has been expanded for the identification of the need for the next processing step (action required). Here, the user role is also taken into account. The only decisive factor in the prior art was the domain.

For example, if on the hospital side, a new request has been created and the approval process is activated for this request type, then after being created, the request has the status “Waiting for approval.” The next processing step must now be performed by a user with the role “hospital manager” (or higher); consequently, the positive identification (action required=yes) is also only required for users with this/these role(s). For hospital users with the roles “hospital coordinator” or “hospital supervisor,” this value is correspondingly set to “no.”

If a user with the role “hospital manager” creates a request for whose request type the approval process is activated, then no immediate change to the status “Requested” occurs.

In this case as well, the request first changes to the status “Waiting for approval.” Consequently, this request is also once again marked as “new” and as “to be processed” (action required=yes) for the user with the role “hospital manager” (or higher).

In another preferred embodiment, the invention relates to the control system; the user sends a query to an organization in order to identify inventories; the inventories are stored in locally available database systems and in remote database systems, characterized in that
1) locally available database systems and/or local copies of inventories from remote database systems are searched and
2) query data are sent to remote database systems, with the database systems being able to respond synchronously and/or asynchronously, and
3) the results are displayed, with the user being provided at particular time intervals with results arriving asynchronously from remote database systems, and
4) the results from remote database systems are stored in the cache.

It is also preferable for the results stored in the cache to be updated.

A user can therefore create a query that is simultaneously sent to all relevant database systems contained within the organizational units. The new and optimized access rights make it possible to quickly and selectively answer customized queries.

It is also preferable for automatic search queries to be regularly sent to remote database systems and for the results to be stored in the cache. Consequently, a user can be informed of the results at regular intervals and can also be informed of recently arrived results. The search therefore delivers especially up-to-date results.

In another preferred embodiment, the invention relates to the use of a control system according to the invention for identifying inventories from locally available database systems and remote database systems, characterized in that
5) locally available database systems and/or local copies of inventories from remote database systems are searched and
6) query data are sent to remote database systems, with the database systems being able to respond synchronously and/or asynchronously, and
7) the results are displayed, with the user being provided at particular time intervals with results arriving asynchronously from remote database systems, and
8) the results from remote database systems are stored in the cache.

The use is particularly preferable when it is intended for identification of an umbilical cord blood unit. It has turned out that primarily in this area, there is a considerable need for systems and platforms that support complex organizational structures and permit searches in distributed inventories. The invention therefore simplifies these processes and is advantageous in comparison to the prior art.

The invention consequently describes a new technology for searching for stem cell products in distributed inventories. It supports complex, decentralized organizational structures that the search function is able to make use of in an advantageous way.

The invention also relates to a method for identifying inventories in which the inventories are stored in locally available database systems and remote database systems, characterized in that
a. locally available database systems and/or local copies of inventories from remote database systems are searched and
b. query data are sent to remote database systems, with the database systems being able to respond synchronously and/or asynchronously, and
c. the results are displayed, with the user being provided at particular time intervals with results arriving asynchronously from remote database systems, and
d. the results from remote database systems are stored in the cache.

The introduction of an approval process for requests by users acting in particular roles for defined organizational units such as hospitals or umbilical cord blood banks permits a particularly efficient execution and rapid processing of such requests. This becomes necessary specifically due to the expanded structural possibilities in the network concept and builds on them.

The system and the method support the searching of inventories of for example stem cell products provided in direct, i.e. locally available, databases or systems and in distributed ones, i.e. ones composed of other databases or systems that are also remote.

The search is performed in hierarchical fashion with the different inventories, based on the different response times and structures:
a) The system first searches locally available inventories and local copies of remote inventories that have been cached from earlier searches.
b) The system sends parallel queries with the patient data to remote systems. The remote systems can respond synchronously and/or asynchronously.
c) The results of the local search are displayed for the user immediately, together with the already found results from the remote systems.
d) The user is informed at adjustable time intervals about results arriving asynchronously from remote systems.
e) If the search results from remote systems include products that have already been identified locally in the cache, then the search result is correspondingly updated and the user is informed of this fact.
f) Results from remote systems are stored locally in the cache in order to keep them locally available for subsequent searches.
g) The system can regularly send artificial search queries to remote systems, which are used to fill the local cache. This function is referred to as “pitching.”

### EXAMPLES AND FIGURES

The access to functionalities for the user of a network with hospitals and umbilical cord blood databases is provided through the combination of corresponding roles. For example, if a user is assigned to a hospital and to an umbilical cord blood database of a network (groups) and if he should in this case have access to all patients and messages, etc., then he must be assigned the roles of “hospital supervisor” and “umbilical cord blood database supervisor.”

FIG. 1 shows a preferred organizational model. It shows the new technical data structures that support the complex organizational structure of the invention.

FIG. 2 shows the available views in the example of an umbilical cord blood database.

FIG. 3 shows a preferred organizational overview. This overview is only accessible to the back office user and displays in tabular fashion all of the organizations that have been created in the platform/system and also offers the functionality of creating all available organizations as well as their users and associated data.

FIG. 4 shows a preferred hospital overview that is used for displaying hospitals and for editing data associated with them.

FIG. 5 shows a preferred umbilical cord blood database overview.

FIG. 6 shows a preferred user overview, which is used for displaying the users and for editing and creating them.

FIG. 7 shows how new users can be created and how existing users can be edited.

FIG. 8 gives an overview of the approval process. The figure schematically depicts the status transitions.

FIG. 9 schematically depicts the structure of the system for searching distributed inventories.

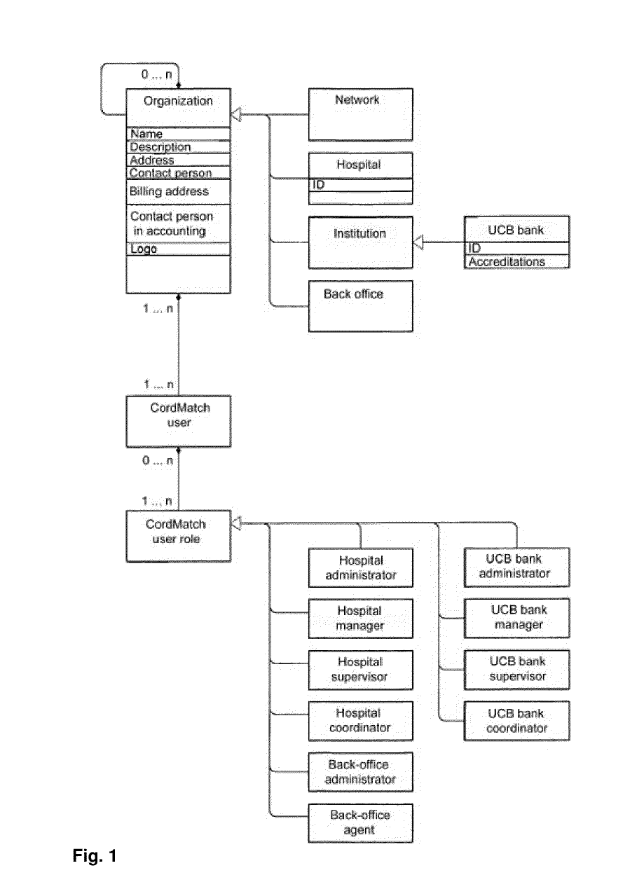

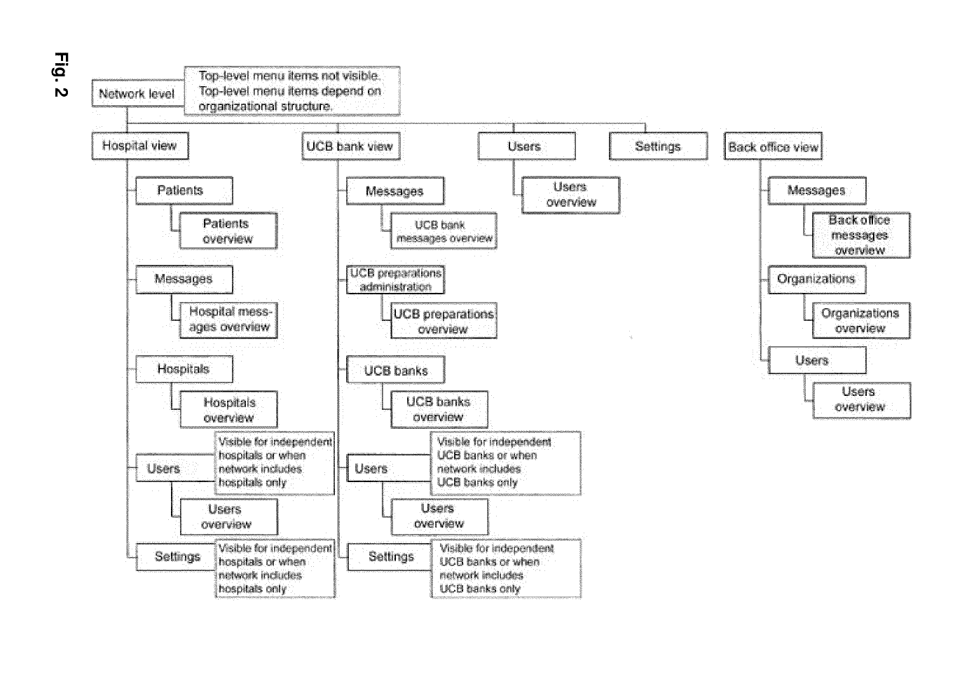

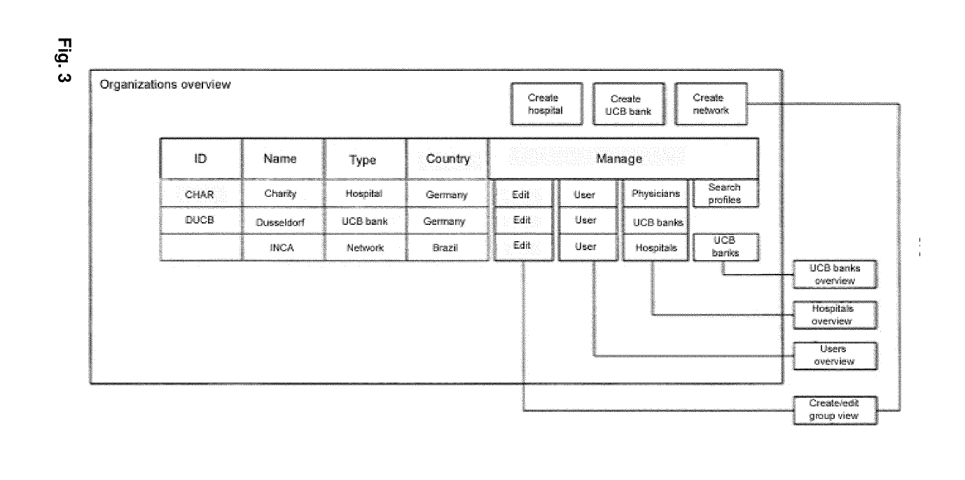

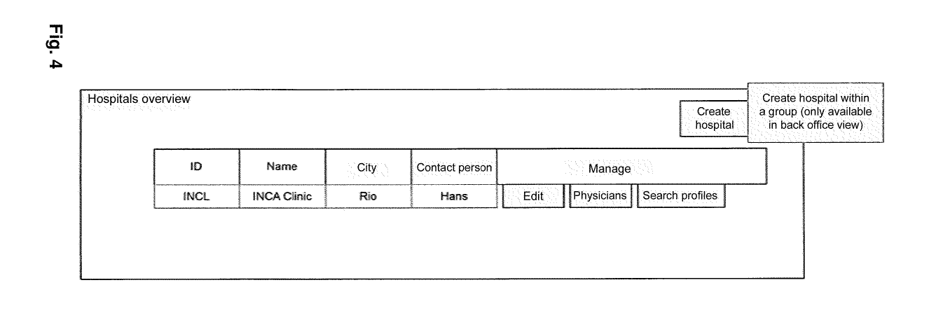

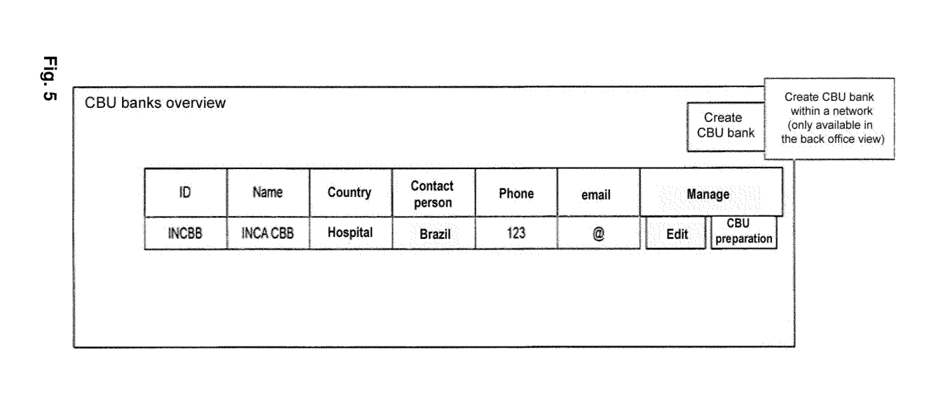

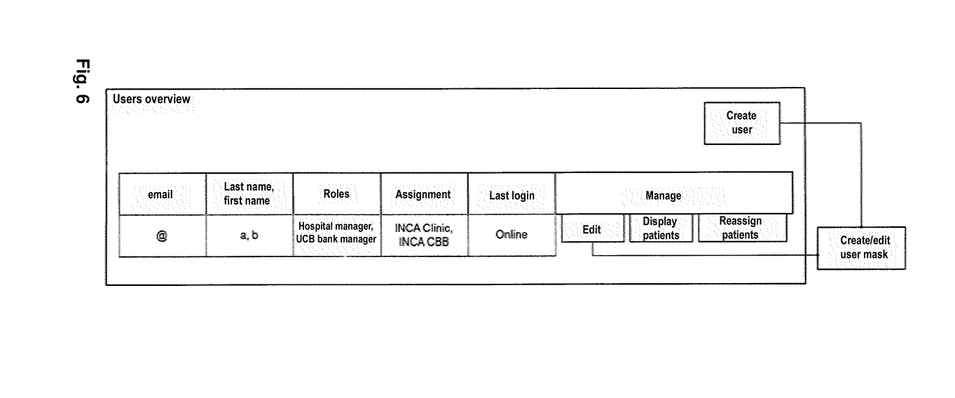

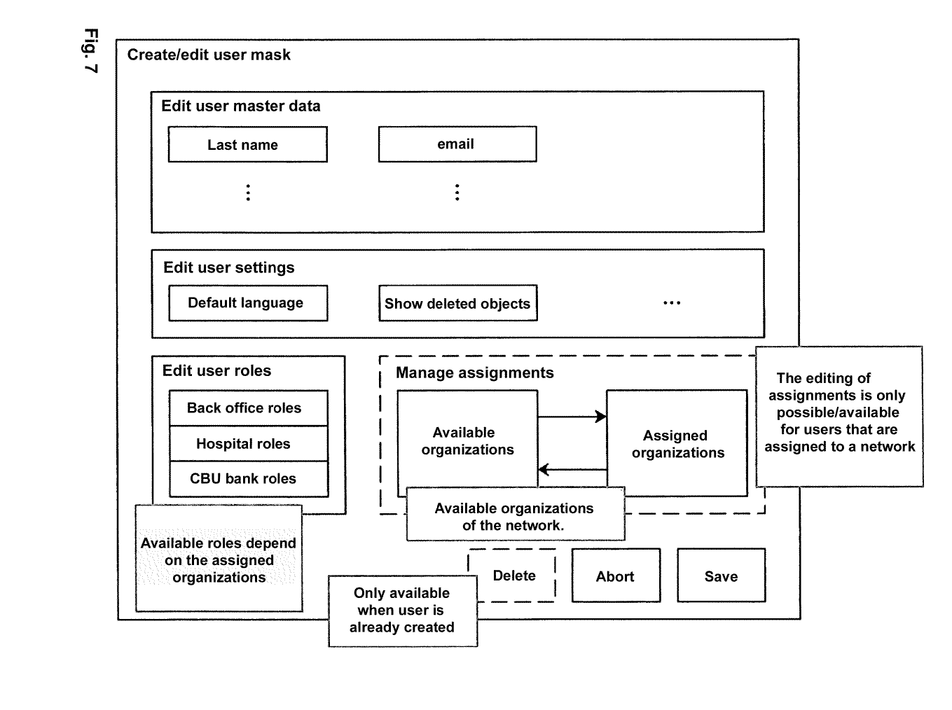

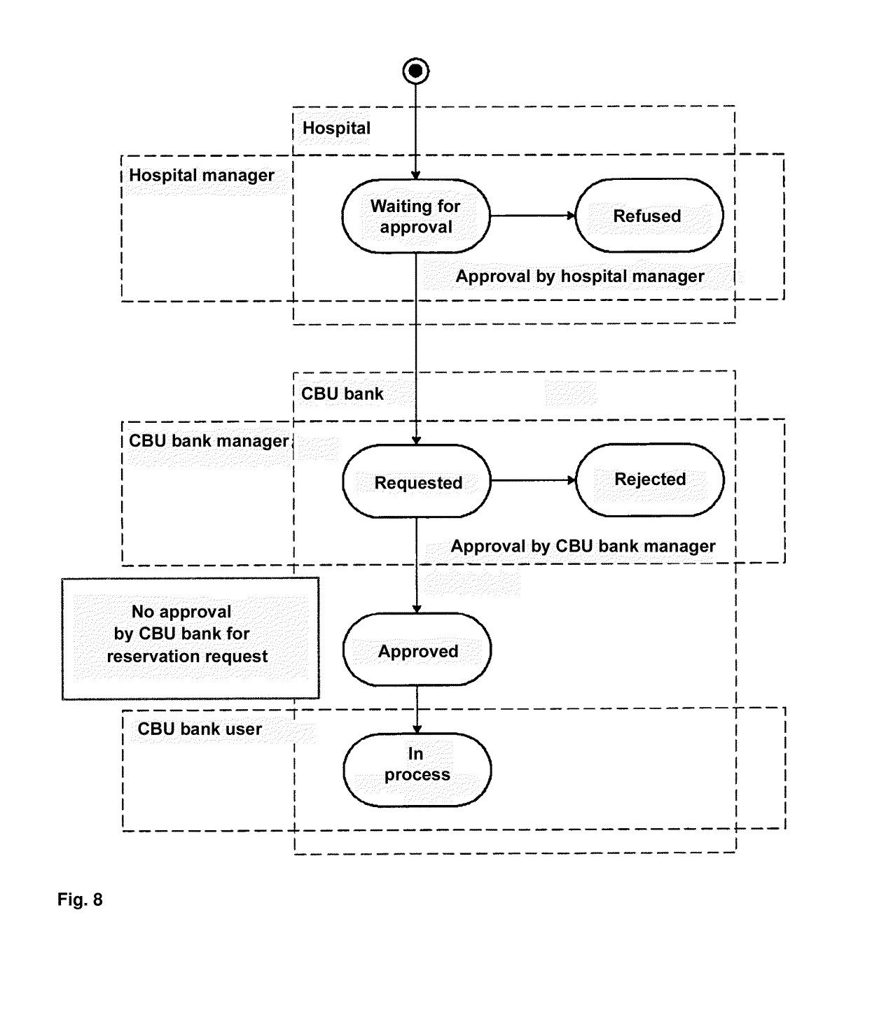

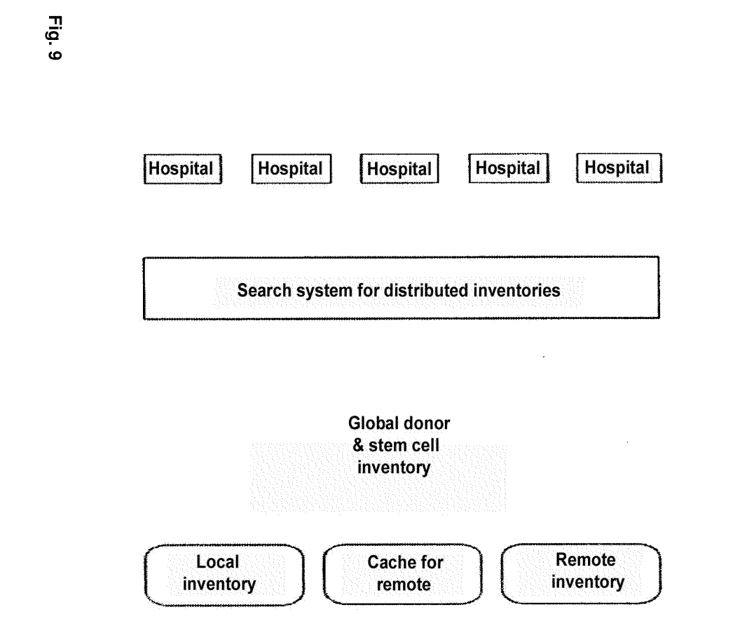

In FIGS. 1 through 9 show the detailed schedule of the request workflow along with all of the requirements for display by the system.

### EXAMPLE 1

User A (hospital+umbilical cord blood database administrator) is assigned to the network A and the units contained therein. The network A is composed of two hospitals and an umbilical cord blood database. Consequently, user A is shown the groups view. He therefore has access to the hospitals view and to the umbilical cord blood databases view and, through the administrator roles, also has access to user administration for the hospitals and for the umbilical cord blood database.

### EXAMPLE 2

In an example for the users view, the following are shown below:

1. Access via the groups view (network with hospitals and umbilical cord blood databases)
Display of all users of the corresponding network
   2. Access via hospitals view (network contains only hospitals)
Display of all users of the hospitals of the network
   3. Access via hospitals view (independent hospitals)
Display of all users of the hospital

TABLE 1.1
Order request - workflow/data

| | | | | | Hospital | | |
|---|---|---|---|---|---|---|---|
| | | | | Hospital | Waiting for | CBB | Hospital |
| Label | Type | Mandatory | Description | Create | approval | Requested | Requested |
| Delivery date | Date | x | Not preset! | x | x | | x |
| Contact | Text | x | Preset with | x | x | | x |
| person | | | the contact | | | | |
| (delivery) | | | person of the | | | | |
| | | | hospital | | | | |
| | | | (complete | | | | |
| | | | contact fields | | | | |
| | | | according to | | | | |
| | | | spec) | | | | |
| Delivery | Text | x | Preset with | x | x | | x |
| address | | | the address of | | | | |
| | | | the patient's | | | | |
| | | | hospital | | | | |
| | | | (complete | | | | |
| | | | contact | | | | |
| | | | according to | | | | |
| | | | spec) | | | | |
| Emergency | Text | x | Not preset! | x | x | | x |
| number | | | | | | | |
| Contact | Text | x | Preset with | x | x | | x |
| person | | | the contact | | | | |
| (coordinator) | | | data of the | | | | |
| | | | SC user | | | | |
| | | | (complete | | | | |
| | | | fields | | | | |
| | | | according to | | | | |
| | | | spec) | | | | |
| Billing address | Text | x | Preset with | x | x | | x |
| | | | the billing | | | | |
| | | | address of the | | | | |
| | | | patient's | | | | |
| | | | hospital | | | | |
| | | | (complete | | | | |
| | | | fields | | | | |
| | | | according to | | | | |
| | | | spec) | | | | |
| Shipment date | Date | x | Not preset! | | | | |
| Shipment | URL | | Not preset! | | | | |
| link | | | | | | | |
| Tracking | String | | Not preset! | | | | |
| number | | | | | | | |
| Shipper | Text | | Not preset! | | | | |
| Comment | Text | | Standard | x | x | x | x |
| | | | comment field | | | | |
| Comment | Display | | Comment | | | | |
| history | | | history | | | | |
| | | | displayed with | | | | |
| | | | the date/time | | | | |
| Created/ | Display | | Creation/modification | | | | |
| modified | | | date | | | | |
| | | | displayed the | | | | |
| | | | same as in | | | | |
| | | | the patient | | | | |
| | | | chart | | | | |
| Create | | | Next status | “Requested” | | | |
| | | | depends on | or “Waiting | | | |
| | | | “Request | for approval” | | | |
| | | | approval” | | | | |
| | | | settings (by | | | | |
| | | | manager) | | | | |
| Approve | | | Approve | | Requested | Approved | |
| | | | button in | | | | |
| | | | “Requested” | | | | |
| | | | status is only | | | | |
| | | | visible on | | | | |
| | | | CBB side | | | | |
| | | | when | | | | |
| | | | “Request | | | | |
| | | | approval” is | | | | |
| | | | activated | | | | |
| Save | | | | | | | Adjusted |
| Shipped | | | | | | | |
| Answer inquiry | | | | | | | |
| Cancel | | | | | Canceled | | Canceled |
| Refuse | | | | | Refused | | |
| Reject | | | | | | Rejected | |
| Inquiry | | | Inquiry button | | | Inquiry | |
| | | | in | | | | |
| | | | “Requested” | | | | |
| | | | status is | | | | |
| | | | hidden on | | | | |
| | | | CBB side | | | | |
| | | | when | | | | |
| | | | “Request | | | | |
| | | | approval” is | | | | |
| | | | activated | | | | |
| Process | | | Process | | | Processing | |
| | | | button in | | | | |
| | | | “Requested” | | | | |
| | | | status is | | | | |
| | | | hidden on | | | | |
| | | | CBB side | | | | |
| | | | when | | | | |
| | | | “Request | | | | |
| | | | approval” is | | | | |
| | | | activated | | | | |
| Shipment | | | | | | | |
| failed | | | | | | | |
| Shipment | | | | | | | |
| received | | | | | | | |

TABLE 1.2
Order request - workflow/data

| | | | | CBB | Hospital | CBB | Hospital |
|---|---|---|---|---|---|---|---|
| Label | Type | Mandatory | Description | Approved | Approved | Inquiry | Inquiry |
| Delivery | Date | x | Not preset! | | x | | x |
| date | | | | | | | |
| Contact | Text | x | Preset with the | | x | | x |
| person | | | contact person of | | | | |
| (delivery) | | | the hospital | | | | |
| | | | (complete contact | | | | |
| | | | fields according to | | | | |
| | | | spec) | | | | |
| Delivery | Text | x | Preset with the | | x | | x |
| address | | | address of the | | | | |
| | | | patient's hospital | | | | |
| | | | (complete contact | | | | |
| | | | according to spec) | | | | |
| Emergency | Text | x | Not preset! | | x | | x |
| number | | | | | | | |
| Contact | Text | x | Preset with the | | x | | x |
| person | | | contact data of the | | | | |
| (coordinator) | | | SC user (complete | | | | |
| | | | fields according to | | | | |
| | | | spec) | | | | |
| Billing | Text | x | Preset with the | | x | | x |
| address | | | billing address of | | | | |
| | | | the patient's | | | | |
| | | | hospital (complete | | | | |
| | | | fields according to | | | | |
| | | | spec) | | | | |
| Shipment | Date | x | Not preset! | | | | |
| date | | | | | | | |
| Shipment | URL | | Not preset! | | | | |
| link | | | | | | | |
| Tracking | String | | Not preset! | | | | |
| number | | | | | | | |
| Shipper | Text | | Not preset! | | | | |
| Comment | Text | | Standard comment | x | x | x | x |
| | | | field | | | | |
| Comment | Display | | Comment history | | | | |
| history | | | displayed with the | | | | |
| | | | date/time | | | | |
| Created/ | Display | | Creation/modification | | | | |
| modified | | | date displayed | | | | |
| | | | the same as in the | | | | |
| | | | patient chart | | | | |
| Create | | | Next status | | | | |
| | | | depends on | | | | |
| | | | “Request approval” | | | | |
| | | | settings (by | | | | |
| | | | manager) | | | | |
| Approve | | | Approve button in | | | | |
| | | | “Requested” status | | | | |
| | | | is only visible on | | | | |
| | | | CBB side when | | | | |
| | | | “Request approval” | | | | |
| | | | is activated | | | | |
| Save | | | | | Adjusted | Inquiry | |
| Shipped | | | | | | | |
| Answer | | | | | | | Inquiry |
| inquiry | | | | | | | answered |
| Cancel | | | | | Canceled | | Canceled |
| Refuse | | | | | | | |
| Reject | | | | Rejected | | Rejected | |
| Inquiry | | | Inquiry button in | Inquiry | | | |
| | | | “Requested” status | | | | |
| | | | is hidden on CBB | | | | |
| | | | side when | | | | |
| | | | “Request approval” | | | | |
| | | | is activated | | | | |
| Process | | | Process button in | Processing | | Processing | |
| | | | “Requested” status | | | | |
| | | | is hidden on CBB | | | | |
| | | | side when | | | | |
| | | | “Request approval” | | | | |
| | | | is activated | | | | |
| Shipment | | | | | | | |
| failed | | | | | | | |
| Shipment | | | | | | | |
| received | | | | | | | |

TABLE 1.3
Order request - workflow/data

| | | | | CBB | Hospital | | |
|---|---|---|---|---|---|---|---|
| | | | | Inquiry | Inquiry | CBB | Hospital |
| Label | Type | Mandatory | Description | answered | answered | Adjusted | Adjusted |
| Delivery | Date | x | Not preset! | | x | | x |
| date | | | | | | | |
| Contact | Text | x | Preset with the | | x | | x |
| person | | | contact person of | | | | |
| (delivery) | | | the hospital | | | | |
| | | | (complete contact | | | | |
| | | | fields according to | | | | |
| | | | spec) | | | | |
| Delivery | Text | x | Preset with the | | x | | x |
| address | | | address of the | | | | |
| | | | patient's hospital | | | | |
| | | | (complete contact | | | | |
| | | | according to spec) | | | | |
| Emergency | Text | x | Not preset! | | x | | x |
| number | | | | | | | |
| Contact | Text | x | Preset with the | | x | | x |
| person | | | contact data of the | | | | |
| (coordinator) | | | SC user (complete | | | | |
| | | | fields according to | | | | |
| | | | spec) | | | | |
| Billing | Text | x | Preset with the | | x | | x |
| address | | | billing address of | | | | |
| | | | the patient's | | | | |
| | | | hospital (complete | | | | |
| | | | fields according to | | | | |
| | | | spec) | | | | |
| Shipment | Date | x | Not preset! | | | | |
| date | | | | | | | |
| Shipment | URL | | Not preset! | | | | |
| link | | | | | | | |
| Tracking | String | | Not preset! | | | | |
| number | | | | | | | |
| Shipper | Text | | Not preset! | | | | |
| Comment | Text | | Standard comment | x | x | x | x |
| | | | field | | | | |
| Comment | Display | | Comment history | | | | |
| history | | | displayed with the | | | | |
| | | | date/time | | | | |
| Created/ | Display | | Creation/modification | | | | |
| modified | | | date displayed the | | | | |
| | | | same as in the | | | | |
| | | | patient chart | | | | |
| Create | | | Next status | | | | |
| | | | depends on | | | | |
| | | | “Request approval” | | | | |
| | | | settings (by | | | | |
| | | | manager) | | | | |
| Approve | | | Approve button in | | | | |
| | | | “Requested” status | | | | |
| | | | is only visible on | | | | |
| | | | CBB side when | | | | |
| | | | “Request approval” | | | | |
| | | | is activated | | | | |
| Save | | | | | Adjusted | | Adjusted |
| Shipped | | | | | | | |
| Answer | | | | | | | |
| inquiry | | | | | | | |
| Cancel | | | | | Canceled | | Canceled |
| Refuse | | | | | | | |
| Reject | | | | Rejected | | Rejected | |
| Inquiry | | | Inquiry button in | Inquiry | | Inquiry | |
| | | | “Requested” status | | | | |
| | | | is hidden on CBB | | | | |
| | | | side when “Request | | | | |
| | | | approval” is | | | | |
| | | | activated | | | | |
| Process | | | Process button in | Processing | | Processing | |
| | | | “Requested” status | | | | |
| | | | is hidden on CBB | | | | |
| | | | side when “Request | | | | |
| | | | approval” is | | | | |
| | | | activated | | | | |
| Shipment | | | | | | | |
| failed | | | | | | | |
| Shipment | | | | | | | |
| received | | | | | | | |

TABLE 1.4
Order request - workflow/data

| | | | | CBB | Hospital | CBB | Hospital |
|---|---|---|---|---|---|---|---|
| Label | Type | Mandatory | Description | Rejected | Rejected | Canceled | Canceled |
| Delivery | Date | x | Not preset! | | | | |
| date | | | | | | | |
| Contact | Text | x | Preset with the | | | | |
| person | | | contact person of | | | | |
| (delivery) | | | the hospital | | | | |
| | | | (complete contact | | | | |
| | | | fields according to | | | | |
| | | | spec) | | | | |
| Delivery | Text | x | Preset with the | | | | |
| address | | | address of the | | | | |
| | | | patient's hospital | | | | |
| | | | (complete contact | | | | |
| | | | according to spec) | | | | |
| Emergency | Text | x | Not preset! | | | | |
| number | | | | | | | |
| Contact | Text | x | Preset with the | | | | |
| person | | | contact data of the | | | | |
| (coordinator) | | | SC user (complete | | | | |
| | | | fields according to | | | | |
| | | | spec) | | | | |
| Billing | Text | x | Preset with the | | | | |
| address | | | billing address of | | | | |
| | | | the patient's | | | | |
| | | | hospital (complete | | | | |
| | | | fields according to | | | | |
| | | | spec) | | | | |
| Shipment | Date | x | Not preset! | | | | |
| date | | | | | | | |
| Shipment | URL | | Not preset! | | | | |
| link | | | | | | | |
| Tracking | String | | Not preset! | | | | |
| number | | | | | | | |
| Shipper | Text | | Not preset! | | | | |
| Comment | Text | | Standard comment | | | | |
| | | | field | | | | |
| Comment | Display | | Comment history | | | | |
| history | | | displayed with the | | | | |
| | | | date/time | | | | |
| Created/ | Display | | Creation/modification | | | | |
| modified | | | date displayed the | | | | |
| | | | same as in the | | | | |
| | | | patient chart | | | | |
| Create | | | Next status | | | | |
| | | | depends on | | | | |
| | | | “Request approval” | | | | |
| | | | settings (by | | | | |
| | | | manager) | | | | |
| Approve | | | Approve button in | | | | |
| | | | “Requested” status | | | | |
| | | | is only visible on | | | | |
| | | | CBB side when | | | | |
| | | | “Request approval” | | | | |
| | | | is activated | | | | |
| Save | | | | | | | |
| Shipped | | | | | | | |
| Answer | | | | | | | |
| inquiry | | | | | | | |
| Cancel | | | | | | | |
| Refuse | | | | | | | |
| Reject | | | | | | | |
| Inquiry | | | Inquiry button in | | | | |
| | | | “Requested” status | | | | |
| | | | is hidden on CBB | | | | |
| | | | side when “Request | | | | |
| | | | approval” is | | | | |
| | | | activated | | | | |
| Process | | | Process button in | | | | |
| | | | “Requested” status | | | | |
| | | | is hidden on CBB | | | | |
| | | | side when “Request | | | | |
| | | | approval” is | | | | |
| | | | activated | | | | |
| Shipment | | | | | | | |
| failed | | | | | | | |
| Shipment | | | | | | | |
| received | | | | | | | |

TABLE 1.5
Order request - workflow/data

| | | | | CBB | Hospital | CBB | Hospital |
|---|---|---|---|---|---|---|---|
| Label | Type | Mandatory | Description | Rejected | Rejected | Canceled | Canceled |
| Delivery date | Date | x | Not preset! | | | | |
| Contact person | Text | x | Preset with the | | | | |
| (delivery) | | | contact person of the | | | | |
| | | | hospital (complete | | | | |
| | | | contact fields | | | | |
| | | | according to spec) | | | | |
| Delivery | Text | x | Preset with the | | | | |
| address | | | address of the | | | | |
| | | | patient's hospital | | | | |
| | | | (complete contact | | | | |
| | | | according to spec) | | | | |
| Emergency | Text | x | Not preset! | | | | |
| number | | | | | | | |
| Contact person | Text | x | Preset with the | | | | |
| (coordinator) | | | contact data of the | | | | |
| | | | SC user (complete | | | | |
| | | | fields according to | | | | |
| | | | spec) | | | | |
| Billing address | Text | x | Preset with the billing | | | | |
| | | | address of the | | | | |
| | | | patient's hospital | | | | |
| | | | (complete fields | | | | |
| | | | according to spec) | | | | |
| Shipment date | Date | x | Not preset! | | | | |
| Shipment | URL | | Not preset! | | | | |
| link | | | | | | | |
| Tracking | String | | Not preset! | | | | |
| number | | | | | | | |
| Shipper | Text | | Not preset! | | | | |
| Comment | Text | | Standard comment | | | | |
| | | | field | | | | |
| Comment | Display | | Comment history | | | | |
| history | | | displayed with the | | | | |
| | | | date/time | | | | |
| Created/ | Display | | Creation/modification | | | | |
| modified | | | date displayed the | | | | |
| | | | same as in the patient | | | | |
| | | | chart | | | | |
| Create | | | Next status depends | | | | |
| | | | on “Request | | | | |
| | | | approval” settings (by | | | | |
| | | | manager) | | | | |
| Approve | | | Approve button in | | | | |
| | | | “Requested” status is | | | | |
| | | | only visible on CBB | | | | |
| | | | side when “Request | | | | |
| | | | approval” is activated | | | | |
| Save | | | | | | | |
| Shipped | | | | | | | |
| Answer inquiry | | | | | | | |
| Cancel | | | | | | | |
| Refuse | | | | | | | |
| Reject | | | | | | | |
| Inquiry | | | Inquiry button in | | | | |
| | | | “Requested” status is | | | | |
| | | | hidden on CBB side | | | | |
| | | | when “Request | | | | |
| | | | approval” is activated | | | | |
| Process | | | Process button in | | | | |
| | | | “Requested” status is | | | | |
| | | | hidden on CBB side | | | | |
| | | | when “Request | | | | |
| | | | approval” is activated | | | | |
| Shipment failed | | | | | | | |
| Shipment | | | | | | | |
| received | | | | | | | |

TABLE 2.1
Reservation request - workflow/data

| | | | | | Hospital | | |
|---|---|---|---|---|---|---|---|
| | | | | | Waiting | CBB | Hospital |
| | | | | Hospital | for | CBU | CBU |
| Label | Type | Mandatory | Description | Create | approval | reserved | reserved |
| Reservation | Date | | Creation date + n | | | | |
| until | | | days (configurable | | | | |
| | | | as of 1.1 by SC), | | | | |
| | | | not editable | | | | |
| Extended | Integer | | n times (how often | | | | |
| | | | the reservation has | | | | |
| | | | already been | | | | |
| | | | extended) not | | | | |
| | | | editable | | | | |
| Comment | Text | | Standard comment | x | x | x | x |
| | | | field | | | | |
| Comment | Display | | Comment history | | | | |
| history | only | | display | | | | |
| Created/ | Display | | Creation/modification | | | | |
| modified | only | | date displayed | | | | |
| | | | the same as in the | | | | |
| | | | patient chart | | | | |
| Create | | | Next status | CBU | | | |
| | | | depends on | reserved or | | | |
| | | | “Request approval” | waiting for | | | |
| | | | settings (by | approval | | | |
| | | | manager) | | | | |
| Approve | | | | | CBU | | |
| | | | | | reserved | | |
| Save | | | | | | | |
| Cancel | | | | | Canceled | | Canceled |
| Refuse | | | | | Refused | | |
| Reject | | | | | | Rejected | |
| Extend | | | | | | | Extended |
| Order | | | | | | | CBU |
| | | | | | | | ordered |

TABLE 2.2
Reservation request - workflow/data

| | | | | CBB | Hospital | CBB | Hospital |
|---|---|---|---|---|---|---|---|
| Label | Type | Mandatory | Description | Extended | Extended | Rejected | Rejected |
| Reservation | Date | | Creation date + n | | | | |
| until | | | days (configurable | | | | |
| | | | as of 1.1 by SC), | | | | |
| | | | not editable | | | | |
| Extended | Integer | | n times (how often | | | | |
| | | | the reservation has | | | | |
| | | | already been | | | | |
| | | | extended) not | | | | |
| | | | editable | | | | |
| Comment | Text | | Standard comment | x | x | | |
| | | | field | | | | |
| Comment | Display | | Comment history | | | | |
| history | only | | display | | | | |
| Created/ | Display | | Creation/modification | | | | |
| modified | only | | date displayed | | | | |
| | | | the same as in the | | | | |
| | | | patient chart | | | | |
| Create | | | Next status | | | | |
| | | | depends on | | | | |
| | | | “Request approval” | | | | |
| | | | settings (by | | | | |
| | | | manager) | | | | |
| Approve | | | | | | | |
| Save | | | | | | | |
| Cancel | | | | | | | |
| Refuse | | | | | | | |
| Reject | | | | Rejected | | | |
| Extend | | | | | Extended | | |
| Order | | | | | CBU | | |
| | | | | | ordered | | |

TABLE 2.3
Reservation request - workflow/data

| | | | | CBB | Hospital | CBB | Hospital |
|---|---|---|---|---|---|---|---|
| Label | Type | Mandatory | Description | Expired | Expired | Canceled | Canceled |
| Reservation | Date | | Creation date + n | | | | |
| until | | | days (configurable | | | | |
| | | | as of 1.1 by SC), | | | | |
| | | | not editable | | | | |
| Extended | Integer | | n times (how often | | | | |
| | | | the reservation has | | | | |
| | | | already been | | | | |
| | | | extended) not | | | | |
| | | | editable | | | | |
| Comment | Text | | Standard comment | | | | |
| | | | field | | | | |
| Comment | Display | | Comment history | | | | |
| history | only | | display | | | | |
| Created/ | Display | | Creation/modification | | | | |
| modified | only | | date displayed | | | | |
| | | | the same as in the | | | | |
| | | | patient chart | | | | |
| Create | | | Next status | | | | |
| | | | depends on | | | | |
| | | | “Request approval” | | | | |
| | | | settings (by | | | | |
| | | | manager) | | | | |
| Approve | | | | | | | |
| Save | | | | | | | |
| Cancel | | | | | | | |
| Refuse | | | | | | | |
| Reject | | | | | | | |
| Extend | | | | | | | |
| Order | | | | | | | |

TABLE 2.4
Reservation request-workflow/data

| | | | | CBB | Hospital |
|---|---|---|---|---|---|
| | | Man- | | CBU | CBU |
| Label | Type | datory | Description | ordered | ordered |
| Reservation | Date | | Creation date + n | | |
| until | | | days (configurable | | |
| | | | as of 1.1 by SC), | | |
| | | | not editable | | |
| Extended | Integer | | n times (how often | | |
| | | | the reservation | | |
| | | | has already been | | |
| | | | extended) not | | |
| | | | editable | | |
| Comment | Text | | Standard comment | | |
| | | | field | | |
| Comment | Display | | Comment history | | |
| history | only | | display | | |
| Created/ | Display | | Creation/ | | |
| modified | only | | modification | | |
| | | | date displayed the | | |
| | | | same as in the | | |
| | | | patient chart | | |
| Create | | | Next status | | |
| | | | depends on | | |
| | | | “Request approval” | | |
| | | | settings (by | | |
| | | | manager) | | |
| Approve | | | | | |
| Save | | | | | |
| Cancel | | | | | |
| Refuse | | | | | |
| Reject | | | | | |
| Extend | | | | | |
| Order | | | | | |

TABLE 3.1
Sample request - workflow/data

| | | | | | Hospital | | |
|---|---|---|---|---|---|---|---|
| | | | | | Waiting | | |
| | | | | Hospital | for | CBB | Hospital |
| Label | Type | Mandatory | Description | Create | approval | Requested | Requested |
| Sample type | List/ | x | “DNA,” “Plasma,” | x | x | | x |
| | single | | “Erythrocytes,” | | | | |
| | choice | | “ALIQUOTS | | | | |
| | | | (other)” | | | | |
| Minimum | Float | x | Float, μg/ml, | x | x | | x |
| quantity | | | 2 decimal places | | | | |
| Contact person | Text | x | Preset with the | x | x | | x |
| (delivery) | | | contact person of | | | | |
| | | | the hospital | | | | |
| | | | (complete contact | | | | |
| | | | fields according | | | | |
| | | | to spec) | | | | |
| Delivery | Text | x | Preset with the | x | x | | x |
| address | | | address of the | | | | |
| | | | patient's hospital | | | | |
| | | | (complete contact | | | | |
| | | | according to | | | | |
| | | | spec) | | | | |
| Emergency | Text | x | Not preset! | x | x | | x |
| number | | | | | | | |
| Contact person | Text | x | Preset with the | x | x | | x |
| (coordinator) | | | contact data of | | | | |
| | | | the SC user | | | | |
| | | | (complete fields | | | | |
| | | | according to | | | | |
| | | | spec) | | | | |
| Billing address | Text | x | Preset with the | x | x | | x |
| | | | billing address of | | | | |
| | | | the patient's | | | | |
| | | | hospital | | | | |
| | | | (complete fields | | | | |
| | | | according to | | | | |
| | | | spec) | | | | |
| Temperature | List/ | x | Not preset! | | | | |
| condition | single | | (Selected from | | | | |
| | choice | | “Room | | | | |
| | | | temperature” or | | | | |
| | | | “Frozen”) | | | | |
| Shipment date | Date | x | Not preset! | | | | |
| Shipment link | URL | | Not preset! | | | | |
| Tracking | String | | Not preset! | | | | |
| number | | | | | | | |
| Shipper | Text | | Not preset! | | | | |
| HLA-A | String | | Values for both | | | | |
| | (HLA | | loci, n digits + N, | | | | |
| | value) | | validation with | | | | |
| | | | HLA validator | | | | |
| HLA-B | String | | Values for both | | | | |
| | (HLA | | loci, n digits + N, | | | | |
| | value) | | validation with | | | | |
| | | | HLA validator | | | | |
| HLA-C | String | | Values for both | | | | |
| | (HLA | | loci, n digits + N, | | | | |
| | value) | | validation with | | | | |
| | | | HLA validator | | | | |
| HLA-DRB1 | String | | Values for both | | | | |
| | (HLA | | loci, n digits + N, | | | | |
| | value) | | validation with | | | | |
| | | | HLA validator | | | | |
| HLA-DQB1 | String | | Values for both | | | | |
| | (HLA | | loci, n digits + N, | | | | |
| | value) | | validation with | | | | |
| | | | HLA validator | | | | |
| Comment | Text | | Standard | x | x | x | x |
| | | | comment field | | | | |
| Comment | Display | | Comment history | | | | |
| history | | | displayed with | | | | |
| | | | the date/time | | | | |
| Created/ | Display | | Creation/modification | | | | |
| modified | | | date | | | | |
| | | | displayed the | | | | |
| | | | same as in the | | | | |
| | | | patient chart | | | | |
| Create | | | Next status | “Requested” | | | |
| | | | depends on | or | | | |
| | | | “Request | “Waiting | | | |
| | | | approval” settings | for | | | |
| | | | (by manager) | approval” | | | |
| Approve | | | Approve button in | | Requested | Approved | |
| | | | “Requested” | | | | |
| | | | status is only | | | | |
| | | | visible on CBB | | | | |
| | | | side when | | | | |
| | | | “Request | | | | |
| | | | approval” is | | | | |
| | | | activated | | | | |
| Save | | | | | | | Requested |
| Shipped | | | | | | | |
| Cancel | | | | | Canceled | | Canceled |
| Refuse | | | | | Refused | | |
| Reject | | | | | | Rejected | |
| Process | | | Process button in | | | Processing | |
| | | | “Requested” | | | | |
| | | | status is hidden | | | | |
| | | | on CBB side | | | | |
| | | | when “Request | | | | |
| | | | approval” is | | | | |
| | | | activated | | | | |
| Shipment failed | | | | | | | |
| Shipment | | | | | | | |
| received | | | | | | | |

TABLE 3.2
Sample request - workflow/data

| | | | | | CBB | Hospital | |
|---|---|---|---|---|---|---|---|
| | | | | Hospital | Shipment | Shipment | CBB |
| Label | Type | Mandatory | Description | Shipped | failed | failed | Received |
| Sample type | List/ | x | “DNA,” “Plasma,” | | | | |
| | single | | “Erythrocytes,” | | | | |
| | choice | | “ALIQUOTS (other)” | | | | |
| Minimum | Float | x | Float, μg/ml, | | | | |
| quantity | | | 2 decimal places | | | | |
| Contact | Text | x | Preset with the | | | | |
| person | | | contact person of | | | | |
| (delivery) | | | the hospital | | | | |
| | | | (complete contact | | | | |
| | | | fields according to | | | | |
| | | | spec) | | | | |
| Delivery | Text | x | Preset with the | | | | |
| address | | | address of the | | | | |
| | | | patient's hospital | | | | |
| | | | (complete contact | | | | |
| | | | according to spec) | | | | |
| Emergency | Text | x | Not preset! | | | | |
| number | | | | | | | |
| Contact | Text | x | Preset with the | | | | |
| person | | | contact data of the | | | | |
| (coordinator) | | | SC user (complete | | | | |
| | | | fields according to | | | | |
| | | | spec) | | | | |
| Billing | Text | x | Preset with the | | | | |
| address | | | billing address of the | | | | |
| | | | patient's hospital | | | | |
| | | | (complete fields | | | | |
| | | | according to spec) | | | | |
| Temperature | List/ | x | Not preset! | | | | |
| condition | single | | (Selected from | | | | |
| | choice | | “Room temperature” | | | | |
| | | | or “Frozen”) | | | | |
| Shipment | Date | x | Not preset! | | | | |
| date | | | | | | | |
| Shipment | URL | | Not preset! | | | | |
| link | | | | | | | |
| Tracking | String | | Not preset! | | | | |
| number | | | | | | | |
| Shipper | Text | | Not preset! | | | | |
| HLA-A | String | | Values for both loci, | | | | |
| | (HLA | | n digits + N, | | | | |
| | value) | | validation with HLA | | | | |
| | | | validator | | | | |
| HLA-B | String | | Values for both loci, | | | | |
| | (HLA | | n digits + N, | | | | |
| | value) | | validation with HLA | | | | |
| | | | validator | | | | |
| HLA-C | String | | Values for both loci, | | | | |
| | (HLA | | n digits + N, | | | | |
| | value) | | validation with HLA | | | | |
| | | | validator | | | | |
| HLA-DRB1 | String | | Values for both loci, | | | | |
| | (HLA | | n digits + N, | | | | |
| | value) | | validation with HLA | | | | |
| | | | validator | | | | |
| HLA-DQB1 | String | | Values for both loci, | | | | |
| | (HLA | | n digits + N, | | | | |
| | value) | | validation with HLA | | | | |
| | | | validator | | | | |
| Comment | Text | | Standard comment | | | | |
| | | | field | | | | |
| Comment | Display | | Comment history | | | | |
| history | | | displayed with the | | | | |
| | | | date/time | | | | |
| Created/ | Display | | Creation/modification | | | | |
| modified | | | date displayed the | | | | |
| | | | same as in the | | | | |
| | | | patient chart | | | | |
| Create | | | Next status depends | “Requested” | | | |
| | | | on “Request | or “Waiting | | | |
| | | | approval” settings | for approval” | | | |
| | | | (by manager) | | | | |
| Approve | | | Approve button in | | | | |
| | | | “Requested” status | | | | |
| | | | is only visible on | | | | |
| | | | CBB side when | | | | |
| | | | “Request approval” | | | | |
| | | | is activated | | | | |
| Save | | | | | | | |
| Shipped | | | | | | | |
| Cancel | | | | | | | |
| Refuse | | | | | | | |
| Reject | | | | | | | |
| Process | | | Process button in | | | | |
| | | | “Requested” status | | | | |
| | | | is hidden on CBB | | | | |
| | | | side when “Request | | | | |
| | | | approval” is | | | | |
| | | | activated | | | | |
| Shipment | | | | | Shipment | | |
| failed | | | | | failed | | |
| Shipment | | | | | Received | | |
| received | | | | | | | |

TABLE 3.3
Sample request - workflow/data

| | | | | | CBB | Hospital |
|---|---|---|---|---|---|---|
| | | | | Hospital | Typing | Typing |
| Label | Type | Mandatory | Description | Received | completed | completed |
| Sample type | List/ | x | “DNA,” “Plasma,” | | | |
| | single | | “Erythrocytes,” | | | |
| | choice | | “ALIQUOTS (other)” | | | |
| Minimum | Float | x | Float, μg/ml, | | | |
| quantity | | | 2 decimal places | | | |
| Contact | Text | x | Preset with the contact | | | |
| person | | | person of the hospital | | | |
| (delivery) | | | (complete contact fields | | | |
| | | | according to spec) | | | |
| Delivery | Text | x | Preset with the address | | | |
| address | | | of the patient's hospital | | | |
| | | | (complete contact | | | |
| | | | according to spec) | | | |
| Emergency | Text | x | Not preset! | | | |
| number | | | | | | |
| Contact | Text | x | Preset with the contact | | | |
| person | | | data of the SC user | | | |
| (coordinator) | | | (complete fields | | | |
| | | | according to spec) | | | |
| Billing | Text | x | Preset with the billing | | | |
| address | | | address of the patient's | | | |
| | | | hospital (complete fields | | | |
| | | | according to spec) | | | |
| Temperature | List/ | x | Not preset! | | | |
| condition | single | | (Selected from “Room | | | |
| | choice | | temperature” or “Frozen”) | | | |
| Shipment | Date | x | Not preset! | | | |
| date | | | | | | |
| Shipment | URL | | Not preset! | | | |
| link | | | | | | |
| Tracking | String | | Not preset! | | | |
| number | | | | | | |
| Shipper | Text | | Not preset! | | | |
| HLA-A | String | | Values for both loci, | x | | |
| | (HLA | | n digits + N, validation | | | |
| | value) | | with HLA validator | | | |
| HLA-B | String | | Values for both loci, | x | | |
| | (HLA | | n digits + N, validation | | | |
| | value) | | with HLA validator | | | |
| HLA-C | String | | Values for both loci, | x | | |
| | (HLA | | n digits + N, validation | | | |
| | value) | | with HLA validator | | | |
| HLA-DRB1 | String | | Values for both loci, | x | | |
| | (HLA | | n digits + N, validation | | | |
| | value) | | with HLA validator | | | |
| HLA-DQB1 | String | | Values for both loci, | x | | |
| | (HLA | | n digits + N, validation | | | |
| | value) | | with HLA validator | | | |
| Comment | Text | | Standard comment field | x | | |
| Comment | Display | | Comment history | | | |
| history | | | displayed with the | | | |
| | | | date/time | | | |
| Created/ | Display | | Creation/modification | | | |
| modified | | | date displayed the same | | | |
| | | | as in the patient chart | | | |
| Create | | | Next status depends on | | | |
| | | | “Request approval” | | | |
| | | | settings (by manager) | | | |
| Approve | | | Approve button in | | | |
| | | | “Requested” status is | | | |
| | | | only visible on CBB side | | | |
| | | | when “Request approval” | | | |
| | | | is activated | | | |
| Save | | | | Typing | | |
| | | | | completed | | |
| Shipped | | | | | | |
| Cancel | | | | | | |
| Refuse | | | | | | |
| Reject | | | | | | |
| Process | | | Process button in | | | |
| | | | “Requested” status is | | | |
| | | | hidden on CBB side when | | | |
| | | | “Request approval” is | | | |
| | | | activated | | | |
| Shipment | | | | | | |
| failed | | | | | | |
| Shipment | | | | | | |
| received | | | | | | |

TABLE 4.1
HLA-typing request - workflow/data

| | | | | | Hospital | | |
|---|---|---|---|---|---|---|---|
| | | | | | Waiting | | |
| | | | | Hospital | for | CBB | Hospital |
| Label | Type | Mandatory | Description | Create | approval | Requested | Requested |
| HLA-A | Display | | Original HLA | | | | |
| display | | | values of the | | | | |
| | | | CBU | | | | |
| HLA-B | Display | | Original HLA | | | | |
| display | | | values of the | | | | |
| | | | CBU | | | | |
| HLA-C | Display | | Original HLA | | | | |
| display | | | values of the | | | | |
| | | | CBU | | | | |
| HLA-DRB1 | Display | | Original HLA | | | | |
| display | | | values of the | | | | |
| | | | CBU | | | | |
| HLA-DQB1 | Display | | Original HLA | | | | |
| display | | | values of the | | | | |
| | | | CBU | | | | |
| HLA-A (Low/ | Option | x | Option fields for | x | | | |
| Medium/ | field | | selecting the | | | | |
| High/None) | | | typing solution | | | | |
| | | | (see screen | | | | |
| | | | layout) Default | | | | |
| | | | completely | | | | |
| | | | empty | | | | |
| HLA-B (Low/ | Option | x | Option fields for | x | | | |
| Medium/ | field | | selecting the | | | | |
| High/None) | | | typing solution | | | | |
| | | | (see screen | | | | |
| | | | layout) Default | | | | |
| | | | completely | | | | |
| | | | empty | | | | |
| HLA-C (Low/ | Option | x | Option fields for | x | | | |
| Medium/ | field | | selecting the | | | | |
| High/None) | | | typing solution | | | | |
| | | | (see screen | | | | |
| | | | layout) Default | | | | |
| | | | completely | | | | |
| | | | empty | | | | |
| HLA-DRB1 | Option | x | Option fields for | x | | | |
| (Low/ | field | | selecting the | | | | |
| Medium/ | | | typing solution | | | | |
| High/None) | | | (see screen | | | | |
| | | | layout) Default | | | | |
| | | | completely | | | | |
| | | | empty | | | | |
| HLA-DQB1 | Option | x | Option fields for | x | | | |
| (Low/ | field | | selecting the | | | | |
| Medium/ | | | typing solution | | | | |
| High/None) | | | (see screen | | | | |
| | | | layout) Default | | | | |
| | | | completely | | | | |
| | | | empty | | | | |
| HLA-A | String | | Values for both | | | | |
| input field | (HLA | | loci, n digits + | | | | |
| | value) | | N, validation | | | | |
| | | | with HLA | | | | |
| | | | validator | | | | |
| HLA-B | String | | Values for both | | | | |
| input field | (HLA | | loci, n digits + | | | | |
| | value) | | N, validation | | | | |
| | | | with HLA | | | | |
| | | | validator | | | | |
| HLA-C | String | | Values for both | | | | |
| input field | (HLA | | loci, n digits + | | | | |
| | value) | | N, validation | | | | |
| | | | with HLA | | | | |
| | | | validator | | | | |
| HLA-DRB1 | String | | Values for both | | | | |
| input field | (HLA | | loci, n digits + | | | | |
| | value) | | N, validation | | | | |
| | | | with HLA | | | | |
| | | | validator | | | | |
| HLA-DQB1 | String | | Values for both | | | | |
| input field | (HLA | | loci, n digits + | | | | |
| | value) | | N, validation | | | | |
| | | | with HLA | | | | |
| | | | validator | | | | |
| Typing | Date | x (not | Date by which | | | x | |
| available by | | mandatory | the typing will | | | | |
| | | in the | probably be | | | | |
| | | status | completed | | | | |
| | | “Requested” | | | | | |
| | | when | | | | | |
| | | “Request | | | | | |
| | | approval” is | | | | | |
| | | activated) | | | | | |
| Contact | Text | x | Preset with the | x | x | | |
| person | | | contact data of | | | | |
| (coordinator) | | | the SC user | | | | |
| | | | (complete fields | | | | |
| | | | according to | | | | |
| | | | spec) | | | | |
| Billing | Text | x | Preset with the | x | x | | |
| address | | | billing address | | | | |
| | | | of the patient's | | | | |
| | | | hospital | | | | |
| | | | (complete fields | | | | |
| | | | according to | | | | |
| | | | spec) | | | | |
| Comment | Text | | Standard | x | x | x | x |
| | | | comment field | | | | |
| Comment | Display | | Comment | | | | |
| history | | | history | | | | |
| | | | displayed with | | | | |
| | | | the date/time | | | | |
| Created/ | Display | | Creation/modification | | | | |
| modified | | | date | | | | |
| | | | displayed the | | | | |
| | | | same as in the | | | | |
| | | | patient chart | | | | |
| Create | | | Next status | “Requested” | | | |
| | | | depends on | or | | | |
| | | | “Request | “Waiting for | | | |
| | | | approval” | approval” | | | |
| | | | settings (by | | | | |
| | | | manager) | | | | |
| Approve | | | Approve button | | Requested | Approved | |
| | | | in “Requested” | | | | |
| | | | status is only | | | | |
| | | | visible on CBB | | | | |
| | | | side when | | | | |
| | | | “Request | | | | |
| | | | approval” is | | | | |
| | | | activated | | | | |
| Save | | | | | | | |
| Cancel | | | | | Canceled | | Canceled |
| Refuse | | | | | Refused | | |
| Reject | | | | | | Rejected | |
| Process | | | Process button | | | Processing | |
| | | | in “Requested” | | | | |
| | | | status is hidden | | | | |
| | | | on CBB side | | | | |
| | | | when “Request | | | | |
| | | | approval” is | | | | |
| | | | activated | | | | |
| Completed | | | | | | | |
| Received | | | | | | | |

TABLE 4.2
HLA-typing request - workflow/data

| | | | | CBB | Hospital | CBB | Hospital |
|---|---|---|---|---|---|---|---|
| Label | Type | Mandatory | Description | Approved | Approved | Processing | Processing |
| HLA-A | Display | | Original HLA | | | | |
| display | | | values of the | | | | |
| | | | CBU | | | | |
| HLA-B | Display | | Original HLA | | | | |
| display | | | values of the | | | | |
| | | | CBU | | | | |
| HLA-C | Display | | Original HLA | | | | |
| display | | | values of the | | | | |
| | | | CBU | | | | |
| HLA-DRB1 | Display | | Original HLA | | | | |
| display | | | values of the | | | | |
| | | | CBU | | | | |
| HLA-DQB1 | Display | | Original HLA | | | | |
| display | | | values of the | | | | |
| | | | CBU | | | | |
| HLA-A (Low/ | Option | x | Option fields for | | | | |
| Medium/ | field | | selecting the | | | | |
| High/None) | | | typing solution | | | | |
| | | | (see screen | | | | |
| | | | layout) Default | | | | |
| | | | completely | | | | |
| | | | empty | | | | |
| HLA-B (Low/ | Option | x | Option fields for | | | | |
| Medium/ | field | | selecting the | | | | |
| High/None) | | | typing solution | | | | |
| | | | (see screen | | | | |
| | | | layout) Default | | | | |
| | | | completely | | | | |
| | | | empty | | | | |
| HLA-C (Low/ | Option | x | Option fields for | | | | |
| Medium/ | field | | selecting the | | | | |
| High/None) | | | typing solution | | | | |
| | | | (see screen | | | | |
| | | | layout) Default | | | | |
| | | | completely | | | | |
| | | | empty | | | | |
| HLA-DRB1 | Option | x | Option fields for | | | | |
| (Low/ | field | | selecting the | | | | |
| Medium/ | | | typing solution | | | | |
| High/None) | | | (see screen | | | | |
| | | | layout) Default | | | | |
| | | | completely | | | | |
| | | | empty | | | | |
| HLA-DQB1 | Option | x | Option fields for | | | | |
| (Low/ | field | | selecting the | | | | |
| Medium/ | | | typing solution | | | | |
| High/None) | | | (see screen | | | | |
| | | | layout) Default | | | | |
| | | | completely | | | | |
| | | | empty | | | | |
| HLA-A | String | | Values for both | | | x | |
| input field | (HLA | | loci, n digits + N, | | | | |
| | value) | | validation with | | | | |
| | | | HLA validator | | | | |
| HLA-B | String | | Values for both | | | x | |
| input field | (HLA | | loci, n digits + N, | | | | |
| | value) | | validation with | | | | |
| | | | HLA validator | | | | |
| HLA-C | String | | Values for both | | | x | |
| input field | (HLA | | loci, n digits + N, | | | | |
| | value) | | validation with | | | | |
| | | | HLA validator | | | | |
| HLA-DRB1 | String | | Values for both | | | x | |
| input field | (HLA | | loci, n digits + N, | | | | |
| | value) | | validation with | | | | |
| | | | HLA validator | | | | |
| HLA-DQB1 | String | | Values for both | | | x | |
| input field | (HLA | | loci, n digits + N, | | | | |
| | value) | | validation with | | | | |
| | | | HLA validator | | | | |
| Typing | Date | x (not | Date by which | x | | x | |
| available by | | mandatory | the typing will | | | | |
| | | in the | probably be | | | | |
| | | status | completed | | | | |
| | | “Requested” | | | | | |
| | | when | | | | | |
| | | “Request | | | | | |
| | | approval” is | | | | | |
| | | activated) | | | | | |
| Contact | Text | x | Preset with the | | | | |
| person | | | contact data of | | | | |
| (coordinator) | | | the SC user | | | | |
| | | | (complete fields | | | | |
| | | | according to | | | | |
| | | | spec) | | | | |
| Billing | Text | x | Preset with the | | | | |
| address | | | billing address | | | | |
| | | | of the patient's | | | | |
| | | | hospital | | | | |
| | | | (complete fields | | | | |
| | | | according to | | | | |
| | | | spec) | | | | |
| Comment | Text | | Standard | x | x | x | x |
| | | | comment field | | | | |
| Comment | Display | | Comment | | | | |
| history | | | history displayed | | | | |
| | | | with the | | | | |
| | | | date/time | | | | |
| Created/ | Display | | Creation/modification | | | | |
| modified | | | date | | | | |
| | | | displayed the | | | | |
| | | | same as in the | | | | |
| | | | patient chart | | | | |
| Create | | | Next status | | | | |
| | | | depends on | | | | |
| | | | “Request | | | | |
| | | | approval” | | | | |
| | | | settings (by | | | | |
| | | | manager) | | | | |
| Approve | | | Approve button | | | | |
| | | | in “Requested” | | | | |
| | | | status is only | | | | |
| | | | visible on CBB | | | | |
| | | | side when | | | | |
| | | | “Request | | | | |
| | | | approval” is | | | | |
| | | | activated | | | | |
| Save | | | | | | | |
| Cancel | | | | | Canceled | | Canceled |
| | | | | | | | (with query/ |
| | | | | | | | cost notice) |
| Refuse | | | | | | | |
| Reject | | | | Rejected | | Rejected | |
| Process | | | Process button | Processing | | | |
| | | | in “Requested” | | | | |
| | | | status is hidden | | | | |
| | | | on CBB side | | | | |
| | | | when “Request | | | | |
| | | | approval” is | | | | |
| | | | activated | | | | |
| Completed | | | | | | Completed | |
| Received | | | | | | | |

TABLE 4.3
HLA-typing request - workflow/data

| | | | | CBB | Hospital | CBB | Hospital |
|---|---|---|---|---|---|---|---|
| Label | Type | Mandatory | Description | Completed | Completed | Received | Received |
| HLA-A | Display | | Original HLA | | | | |
| display | | | values of the CBU | | | | |
| HLA-B | Display | | Original HLA | | | | |
| display | | | values of the CBU | | | | |
| HLA-C | Display | | Original HLA | | | | |
| display | | | values of the CBU | | | | |
| HLA-DRB1 | Display | | Original HLA | | | | |
| display | | | values of the CBU | | | | |
| HLA-DQB1 | Display | | Original HLA | | | | |
| display | | | values of the CBU | | | | |
| HLA-A (Low/ | Option | x | Option fields for | | | | |
| Medium/ | field | | selecting the typing | | | | |
| High/None) | | | solution (see | | | | |
| | | | screen layout) | | | | |
| | | | Default completely | | | | |
| | | | empty | | | | |
| HLA-B (Low/ | Option | x | Option fields for | | | | |
| Medium/ | field | | selecting the typing | | | | |
| High/None) | | | solution (see | | | | |
| | | | screen layout) | | | | |
| | | | Default completely | | | | |
| | | | empty | | | | |
| HLA-C (Low/ | Option | x | Option fields for | | | | |
| Medium/ | field | | selecting the typing | | | | |
| High/None) | | | solution (see | | | | |
| | | | screen layout) | | | | |
| | | | Default completely | | | | |
| | | | empty | | | | |
| HLA-DRB1 | Option | x | Option fields for | | | | |
| (Low/ | field | | selecting the typing | | | | |
| Medium/ | | | solution (see | | | | |
| High/None) | | | screen layout) | | | | |
| | | | Default completely | | | | |
| | | | empty | | | | |
| HLA-DQB1 | Option | x | Option fields for | | | | |
| (Low/ | field | | selecting the typing | | | | |
| Medium/ | | | solution (see | | | | |
| High/None) | | | screen layout) | | | | |
| | | | Default completely | | | | |
| | | | empty | | | | |
| HLA-A | String | | Values for both loci, | | | | |
| input field | (HLA | | n digits + N, | | | | |
| | value) | | validation with HLA | | | | |
| | | | validator | | | | |
| HLA-B | String | | Values for both loci, | | | | |
| input field | (HLA | | n digits + N, | | | | |
| | value) | | validation with HLA | | | | |
| | | | validator | | | | |
| HLA-C | String | | Values for both loci, | | | | |
| input field | (HLA | | n digits + N, | | | | |
| | value) | | validation with HLA | | | | |
| | | | validator | | | | |
| HLA-DRB1 | String | | Values for both loci, | | | | |
| input field | (HLA | | n digits + N, | | | | |
| | value) | | validation with HLA | | | | |
| | | | validator | | | | |
| HLA-DQB1 | String | | Values for both loci, | | | | |
| input field | (HLA | | n digits + N, | | | | |
| | value) | | validation with HLA | | | | |
| | | | validator | | | | |
| Typing | Date | x (not | Date by which the | | | | |
| available by | | mandatory | typing will probably | | | | |
| | | in the | be completed | | | | |
| | | status | | | | | |
| | | “Requested” | | | | | |
| | | when | | | | | |
| | | “Request | | | | | |
| | | approval” is | | | | | |
| | | activated) | | | | | |
| Contact | Text | x | Preset with the | | | | |
| person | | | contact data of the | | | | |
| (coordinator) | | | SC user (complete | | | | |
| | | | fields according to | | | | |
| | | | spec) | | | | |
| Billing | Text | x | Preset with the | | | | |
| address | | | billing address of | | | | |
| | | | the patient's | | | | |
| | | | hospital (complete | | | | |
| | | | fields according to | | | | |
| | | | spec) | | | | |
| Comment | Text | | Standard comment | | x | | |
| | | | field | | | | |
| Comment | Display | | Comment history | | | | |
| history | | | displayed with the | | | | |
| | | | date/time | | | | |
| Created/ | Display | | Creation/modification | | | | |
| modified | | | date displayed | | | | |
| | | | the same as in the | | | | |
| | | | patient chart | | | | |
| Create | | | Next status | | | | |
| | | | depends on | | | | |
| | | | “Request approval” | | | | |
| | | | settings (by | | | | |
| | | | manager) | | | | |
| Approve | | | Approve button in | | | | |
| | | | “Requested” status | | | | |
| | | | is only visible on | | | | |
| | | | CBB side when | | | | |
| | | | “Request approval” | | | | |
| | | | is activated | | | | |
| Save | | | | | | | |
| Cancel | | | | | | | |
| Refuse | | | | | | | |
| Reject | | | | | | | |
| Process | | | Process button in | | | | |
| | | | “Requested” status | | | | |
| | | | is hidden on CBB | | | | |
| | | | side when | | | | |
| | | | “Request approval” | | | | |
| | | | is activated | | | | |
| Completed | | | | | | | |
| Received | | | | | Received | | |

TABLE 5.1
Colony assay request - workflow/data

| | | | | | Hospital | | |
|---|---|---|---|---|---|---|---|
| | | | | CBB | Waiting for | CBB | Hospital |
| Label | Type | Mandatory | Description | Create | approval | Requested | Requested |
| Available | Date | x (not | Date by which the | | | x | |
| by | | mandatory | result will be | | | | |
| | | in the | available | | | | |
| | | status | | | | | |
| | | “Requested” | | | | | |
| | | when | | | | | |
| | | “Request | | | | | |
| | | approval” is | | | | | |
| | | activated) | | | | | |
| BFU-E | Float | | | | | | |
| CFU-GM | Float | | | | | | |
| CFU- | Float | | | | | | |
| GEMM | | | | | | | |
| Additional | Text | | Multiline text field | | | | |
| results | | | for further results | | | | |
| Contact | Text | x | Preset with the | x | x | | |
| person | | | contact data of the | | | | |
| (coordinator) | | | SC user (field not in | | | | |
| | | | spec, but please | | | | |
| | | | complete if this is | | | | |
| | | | possible without too | | | | |
| | | | much work) | | | | |
| Billing | Text | x | Preset with the | x | x | | |
| address | | | billing address of | | | | |
| | | | the patient's | | | | |
| | | | hospital (complete | | | | |
| | | | fields according to | | | | |
| | | | spec) | | | | |
| Comment | Text | | Standard comment | x | x | x | x |
| | | | field | | | | |
| Comment | Display | | Comment history | | | | |
| history | | | displayed with the | | | | |
| | | | date/time | | | | |
| Created/ | Display | | Creation/modification | | | | |
| modified | | | date displayed | | | | |
| | | | the same as in the | | | | |
| | | | patient chart | | | | |
| Create | | | Next status | “Requested” | | | |
| | | | depends on | or | | | |
| | | | “Request approval” | “Waiting for | | | |
| | | | settings (by | approval” | | | |
| | | | manager) | | | | |
| Approve | | | Approve button in | | Requested | Approved | |
| | | | “Requested” status | | | | |
| | | | is only visible on | | | | |
| | | | CBB side when | | | | |
| | | | “Request approval” | | | | |
| | | | is activated | | | | |
| Save | | | | | | | |
| Cancel | | | | | Canceled | | Canceled |
| Refuse | | | | | Refused | | |
| Reject | | | | | | Rejected | |
| Process | | | Process button in | | | Processing | |
| | | | “Requested” status | | | | |
| | | | is hidden on CBB | | | | |
| | | | side when | | | | |
| | | | “Request approval” | | | | |
| | | | is activated | | | | |
| Completed | | | | | | | |
| Received | | | | | | | |

TABLE 5.2
Colony assay request - workflow/data

| | | | | CBB | Hospital | CBB | Hospital |
|---|---|---|---|---|---|---|---|
| Label | Type | Mandatory | Description | Approved | Approved | Processing | Processing |
| Available by | Date | x (not | Date by which the | x | | x | |
| | | mandatory | result will be | | | | |
| | | in the | available | | | | |
| | | status | | | | | |
| | | “Requested” | | | | | |
| | | when | | | | | |
| | | “Request | | | | | |
| | | approval” is | | | | | |
| | | activated) | | | | | |
| BFU-E | Float | | | | | x | |
| CFU-GM | Float | | | | | x | |
| CFU-GEMM | Float | | | | | x | |
| Additional | Text | | Multiline text field | | | x | |
| results | | | for further results | | | | |
| Contact | Text | x | Preset with the | | | | |
| person | | | contact data of the | | | | |
| (coordinator) | | | SC user (field not in | | | | |
| | | | spec, but please | | | | |
| | | | complete if this is | | | | |
| | | | possible without too | | | | |
| | | | much work) | | | | |
| Billing | Text | x | Preset with the | | | | |
| address | | | billing address of | | | | |
| | | | the patient's | | | | |
| | | | hospital (complete | | | | |
| | | | fields according to | | | | |
| | | | spec) | | | | |
| Comment | Text | | Standard comment | x | x | x | x |
| | | | field | | | | |
| Comment | Display | | Comment history | | | | |
| history | | | displayed with the | | | | |
| | | | date/time | | | | |
| Created/ | Display | | Creation/modification | | | | |
| modified | | | date displayed | | | | |
| | | | the same as in the | | | | |
| | | | patient chart | | | | |
| Create | | | Next status | | | | |
| | | | depends on | | | | |
| | | | “Request approval” | | | | |
| | | | settings (by | | | | |
| | | | manager) | | | | |
| Approve | | | Approve button in | | | | |
| | | | “Requested” status | | | | |
| | | | is only visible on | | | | |
| | | | CBB side when | | | | |
| | | | “Request approval” | | | | |
| | | | is activated | | | | |
| Save | | | | | | | |
| Cancel | | | | | Canceled | | Canceled |
| | | | | | | | (with query/ |
| | | | | | | | cost notice) |
| Refuse | | | | | | | |
| Reject | | | | Rejected | | Rejected | |
| Process | | | Process button in | Processing | | | |
| | | | “Requested” status | | | | |
| | | | is hidden on CBB | | | | |
| | | | side when | | | | |
| | | | “Request approval” | | | | |
| | | | is activated | | | | |
| Completed | | | | | | Completed | |
| Received | | | | | | | |

TABLE 5.3
Colony assay request - workflow/data

| | | | | CBB | Hospital | CBB | Hospital |
|---|---|---|---|---|---|---|---|
| Label | Type | Mandatory | Description | Completed | Completed | Received | Received |
| Available by | Date | x (not | Date by which the | | | | |
| | | mandatory | result will be | | | | |
| | | in the | available | | | | |
| | | status | | | | | |
| | | “Requested” | | | | | |
| | | when | | | | | |
| | | “Request | | | | | |
| | | approval” is | | | | | |
| | | activated) | | | | | |
| BFU-E | Float | | | | | | |
| CFU-GM | Float | | | | | | |
| CFU-GEMM | Float | | | | | | |
| Additional | Text | | Multiline text field | | | | |
| results | | | for further results | | | | |
| Contact | Text | x | Preset with the | | | | |
| person | | | contact data of the | | | | |
| (coordinator) | | | SC user (field not in | | | | |
| | | | spec, but please | | | | |
| | | | complete if this is | | | | |
| | | | possible without too | | | | |
| | | | much work) | | | | |
| Billing | Text | x | Preset with the | | | | |
| address | | | billing address of | | | | |
| | | | the patient's | | | | |
| | | | hospital (complete | | | | |
| | | | fields according to | | | | |
| | | | spec) | | | | |
| Comment | Text | | Standard comment | | x | | |
| | | | field | | | | |
| Comment | Display | | Comment history | | | | |
| history | | | displayed with the | | | | |
| | | | date/time | | | | |
| Created/ | Display | | Creation/modification | | | | |
| modified | | | date displayed | | | | |
| | | | the same as in the | | | | |
| | | | patient chart | | | | |
| Create | | | Next status | | | | |
| | | | depends on | | | | |
| | | | “Request approval” | | | | |
| | | | settings (by | | | | |
| | | | manager) | | | | |
| Approve | | | Approve button in | | | | |
| | | | “Requested” status | | | | |
| | | | is only visible on | | | | |
| | | | CBB side when | | | | |
| | | | “Request approval” | | | | |
| | | | is activated | | | | |
| Save | | | | | | | |
| Cancel | | | | | | | |
| Refuse | | | | | | | |
| Reject | | | | | | | |
| Process | | | Process button in | | | | |
| | | | “Requested” status | | | | |
| | | | is hidden on CBB | | | | |
| | | | side when | | | | |
| | | | “Request approval” | | | | |
| | | | is activated | | | | |
| Completed | | | | | | | |
| Received | | | | | Received | | |

TABLE 6
Abstract request status text

| Request type | Status | Text |
|---|---|---|
| All | Any | <requesttype> - <status> at <date of status change> |
| Special cases | | |
| Reservation | Reserved\Extended | Reserved until <reservation until date> |
| Order | Processing\Shipped | <requesttype> - <status> delivery at <delivery date > |
| HLA typing, sample, | Processing | <requesttype> - <status> since <date of status |
| colony assay | | change> |
| Sample | Shipped | <requesttype> - shipped on <shipment date> |
| All | Waiting for approval | <requesttype> - <status> since <date of status |
| | | change> |

TABLE 7
Request confirmation dialog text (scheme)

| Request type | Part | Action | Message type | Text |
|---|---|---|---|---|
| All | C/CBB/BO | Any | Message | Do you really want to <action> the |
| | | | | <requesttype> request? |
| Special cases | | | | |
| All | CBB/BO | Reject | Warning | Do you really want to reject the |
| | | | | <requesttype> request? |
| Reservation | C | Cancel | Warning | Do you really want to cancel the |
| | | | | <requesttype> request? |
| Order, DNA | C | Cancel | Warning | Do you really want to cancel the |
| sample, HLA | | | | <requesttype> request? There may be |
| typing, colony | | | | costs associated. |
| assay | | | | |
| Order, DNA | C | Create | Warning | Do you really want to cancel the |
| sample, HLA | | | | <requesttype> request? You will be |
| typing, colony | | | | charged for the costs incurred. |
| assay | | | | |
| Order, DNA | C | Approve | Warning | Do you really want to cancel the |
| sample, HLA | | | | <requesttype>request? You will be |
| typing, colony | | | | charged for the costs incurred. |
| assay | | | | |
| Order | CBB | Inquiry | Message | Do you really want to place an inquiry |
| | | placed | | for the <requesttype> request? |
| Order | C | Inquiry | Message | Do you really want to answer the inquiry |
| | | answered | | for the <requesttype> request? |
| Order, DNA | CBB | Shipped | Message | Do you really want to set the |
| sample | | | | <requesttype> request to “Shipped”? |
| Order, DNA | C | Shipping | Message | Do you really want to set the |
| sample | | failed | | <requesttype> request to “Shipping |
| | | | | failed”? |
| Order, DNA | C | Received | Message | Do you really want to set the |
| sample, HLA | | | | <requesttype> request to “Received”? |
| typing, colony | | | | |
| assay | | | | |
| DNA sample, | C/CBB | (Typing) | Message | Do you really want to set the |
| HLA typing, | | completed | | <requesttype> request to “Completed”? |
| colony assay | | | | |

C—hospital
CBB—cord blood bank
BO—back office

TABLE 8
Request mask status graphics
Steps in request graphic

| | | | | | | |
|---|---|---|---|---|---|---|
| Step 1 | Step 2 | Step 3 | Step 4 | Step 5 | Step 6 | In status |

HLA typing request

| | | | | | |
|---|---|---|---|---|---|
| Create | Requested | Processing | Completed | Received | “Creation” or |
| | | | | | “Waiting for approval” |
| Create | Requested | Processing | Completed | Received | Requested |
| Create | Requested | Processing | Completed | Received | “Approved” or |
| | | | | | “Processing” |
| Create | Requested | Processing | Completed | Received | Completed |
| Create | Requested | Processing | Completed | Received | Received |
| Create | Requested | Canceled | | | Canceled |
| Create | Requested | Rejected | | | Rejected |
| Create | Refused | | | | Refused |

Order request

| | | | | | | |
|---|---|---|---|---|---|---|
| Create | Requested | Processing | Shipped | Received | | “Creation” or |
| | | | | | | “Waiting for approval” |
| Create | Requested | Processing | Shipped | Received | | Requested |
| Create | Requested | Processing | Shipped | Received | | “Approved” or |
| | | | | | | “Processing” |
| Create | Requested | Processing | Shipped | Received | | Shipped |
| Create | Requested | Processing | Shipped | Received | | Received |
| Create | Requested | Processing | Shipped | Shipment | | Shipment failed |
| | | | | failed | | |
| Create | Requested | Inquiry | Processing | Shipped | Received | Inquiry |
| Create | Requested | Inquiry | Processing | Shipped | Received | Inquiry answered |
| | | answered | | | | |
| Create | Requested | Processing | Adjusted | Shipped | Received | Adjusted |
| Create | Requested | Canceled | | | | Canceled |
| Create | Requested | Rejected | | | | Rejected |
| Create | Refused | | | | | Refused |

Sample request

| | | | | | | |
|---|---|---|---|---|---|---|
| Create | Requested | Processing | Shipped | Received | Typing | “Creation” or |
| | | | | | comp. | “Waiting for approval” |
| Create | Requested | Processing | Shipped | Received | Typing | Requested |
| | | | | | comp. | |
| Create | Requested | Processing | Shipped | Received | Typing | “Approved” or |
| | | | | | comp. | “Processing” |
| Create | Requested | Processing | Shipped | Received | Typing | Shipped |
| | | | | | comp. | |
| Create | Requested | Processing | Shipped | Received | Typing | Received |
| | | | | | comp. | |
| Create | Requested | Processing | Shipped | Received | Typing | Typing completed |
| | | | | | compl. | |
| Create | Requested | Processing | Shipped | Shipment | | Shipment failed |
| | | | | failed | | |
| Create | Requested | Canceled | | | | Canceled |
| Create | Requested | Rejected | | | | Rejected |
| Create | Refused | | | | | Refused |

Reservation request

| | | | | |
|---|---|---|---|---|
| Create | CBU | CBU | | “Creation” or |
| | reserved | ordered | | “Waiting for approval” |
| Create | CBU | CBU | | CBU reserved |
| | reserved | ordered | | |
| Create | CBU | CBU | | CBU ordered |
| | reserved | ordered | | |
| Create | CBU | Extended | CBU | Extended |
| | reserved | | ordered | |
| Create | CBU | Expired | | Expired |
| | reserved | | | |
| Create | CBU | Canceled | | Canceled |
| | reserved | | | |
| Create | CBU | Rejected | | Rejected |
| | reserved | | | |
| Create | Refused | | | Refused |

Colony assay request

| | | | | | |
|---|---|---|---|---|---|
| Create | Requested | Processing | Completed | Received | “Creation” or “Waiting for |
| | | | | | approval” |
| Create | Requested | Processing | Completed | Received | Requested |
| Create | Requested | Processing | Completed | Received | “Approved” or |
| | | | | | “Processing” |
| Create | Requested | Processing | Completed | Received | Completed |
| Create | Requested | Processing | Completed | Received | Received |
| Create | Requested | Canceled | | | Canceled |
| Create | Requested | Rejected | | | Rejected |
| Create | Refused | | | | Refused |

TABLE 9.1
Request conditions overview (visibility/editability)

| | Hospital | | | | | |
|---|---|---|---|---|---|---|
| | | Manager + | | Supervisor + | | Coordinator + |
| | Manager | owner | Supervisor | owner | Coordinator | owner |
| “Waiting for approval” | S/M/A | S/M/A | S | S | S | S |
| “Cancel” | S | S | S | S | S | S |
| “Refused” | S | S | S | S/M | S | S/M |
| “Requested” | S | S | S | S | S | S |
| (approval active) | | | | | | |
| “Requested” | S | S | S | S | S | S |
| (no approval) | | | | | | |
| “Approved” | S | S | S | S | S | S |
| “Rejected” | S | S/M | S | S/M | S | S/M |
| “Inquiry” | S | S/M/A | S | S/M/A | S | S/M/A |
| “Inquiry answered” | S | S | S | S | S | S |
| “Processing” | S | S/M | S | S/M | S | S/M |
| “Adjusted” | S | S | S | S | S | S |
| “Shipped” | S | S/M/A | S | S/M/A | S | S/M/A |
| “Shipping failed” | S | S | S | S | S | S |
| “Received” | S | S/M*/A* | S | S/M*/A* | S | S/M*/A* |
| “Completed” | S | S/M/A | S | S/M/A | S | S/M/A |
| “Typing completed” | S | S | S | S | S | S |
| “Extended” | S | S | S | S | S | S |
| “Expired” | S | S/M | S | S/M | S | S/M |

TABLE 9.2
Request conditions overview (visibility/editability)

| | CBB | | | |
|---|---|---|---|---|
| | Manager | Supervisor | Coordinator | Comments |
| “Waiting for | — | — | — | |
| approval” | | | | |
| “Cancel” | S | S/M* | S/M* | * Prerequisite on CBB side, before |
| | | | | reaching the status “Canceled,” the |
| | | | | request was already visible on the CBB |
| | | | | side. |
| “Refused” | — | — | — | |
| “Requested” | S/M/A | — | — | |
| (approval active) | | | | |
| “Requested” | S | S/M/A | S/M/A | |
| (no approval) | | | | |
| “Approved” | S | S/M/A | S/M/A | |
| “Rejected” | S | S | S | |
| “Inquiry” | S | S | S | |
| “Inquiry | S | S/M/A | S/M/A | |
| answered” | | | | |
| “Processing” | S | S/A | S/A | |
| “Adjusted” | S | S/M/A | S/M/A | |
| “Shipped” | S | S | S | |
| “Shipping failed” | S | S/M | S/M | |
| “Received” | S | S/M | S/M | * Only in the case of the sample request |
| “Completed” | S | S | S | |
| “Typing | S | S | S | |
| completed” | | | | |
| “Extended” | S | S/M | S/M | |
| “Expired” | S | S | S | |

S=Shown: The user can see the request in the request overview. Here, too, the user must generally be assigned to the hospital/CBB and hospital coordinators see only their own requests.
M=Marking: The request is marked for the user when it reaches the status marked. After the request is activated, the marking disappears. If the request reaches the same status again because a user with a role on the other side (hospital roles versus CBB roles) has made a change, then the request is marked again (for example saving again after a change to the hospital address of a request with the status “Requested” results in the request being marked again on the CBB side)
A=Action required: The user must perform an action in order to continue the workflow. The field “Action required” is set to “Yes.”
Owner: The user is the owner of the request, i.e. he is assigned to the patient to which the solution and the associated CBUs and their requests belong.

1. A control system for distributed organizational structures, comprising:
at least one organization with at least one organizational unit, wherein the at least one organizational unit has technical attributes and can be a providers and/or an inquiring party;
at least two users, and data structures configured to
assign the at least two the users to at least one organization; and at least one role,
wherein the role is assigned to at least one user and
wherein the role determines the available functionalities within the organization that is assigned to the user,
wherein the organization to which a user is assigned determines the view that is shown to the user and
wherein a first user can create a search request, which is sent to organizations that comprise provider organizational units and
wherein the user can then send a request to an organization and
wherein further user that is assigned to the organization to which the request has been made processes the request.

2. The control system according to claim 1,
wherein the organizational unit is selected from the group consisting of the network, hospital, institution, administration and a combination thereof.

3. The control system according to claim 2,
wherein the network comprises two clinics, a network of at least two institutions or a network of at least one clinic and at least one institution.

4. The control system according to claim 1,
wherein the institution is selected from the group consisting of an umbilical cord blood bank, a blood bank, a stem cell bank, a tissue bank, an organ bank and a combination thereof.

5. The control system according to claim 1,
wherein the role is selected from the group comprising administrator, manager, supervisor, and coordinator.

6. The control system according to claim 1,
wherein the roles are hierarchically arranged.

7. The control system according to claim 1,
wherein the further user that is assigned to the organization to which the query has been submitted processes the query, namely accepts it, and as a result, the user that has submitted the query is shown that the query has been accepted.

8. The control system according to claim 1,
wherein the further user that is assigned to the organization to which the query has been submitted processes the query and activates an approval step.

9. The control system according to claim 1,
wherein the user sends a query to an organization in order to identify inventories
wherein the inventories are stored in locally available database systems and in remote database systems,
wherein
(i) locally available database systems and/or local copies of inventories from remote database systems are searched and
(ii) query data are sent to remote database systems,
wherein the database systems are able to respond synchronously and/or asynchronously, and
(iii) results are displayed,
wherein the user is provided at particular time intervals with the results arriving asynchronously from remote database systems, and
(iv) wherein the results from remote database systems are stored in a cache of the system.

10. The control system according to claim 9,
wherein the results stored in the cache are updated.

11. The control system according to claim 9,
wherein automatic search queries are regularly sent to remote database systems and the results are stored in the cache

12. A method for identifying inventories from locally available database systems and remote database systems via the control system of claim 1,
the method comprising
(i) searching locally available database systems and/or local copies of inventories from remote database systems and
(ii) sending query data to remote database systems,
wherein the database systems are able to respond synchronously and/or asynchronously, and
(iii) the systems displays results,
wherein the user is provided at particular time intervals with the results arriving asynchronously from remote database systems, and
(iv) the results from the remote database systems are stored in a cache of the system.

13. The method of claim 12, wherein the results comprise an umbilical cord blood unit that has been identified.

14. The control system according to claim 10,
wherein automatic search queries are regularly sent to remote database systems and the results are stored in a cache of the system.

15. A method for identifying inventories from locally available database systems and remote database systems via the control system of claim 9,
the method comprising
(i) searching locally available database systems and/or local copies of inventories from remote database systems and
(ii) sending query data to remote database systems,
wherein the database systems are able to respond synchronously and/or asynchronously, and
(iii) the systems displays results,
wherein the user is provided at particular time intervals with the results arriving asynchronously from remote database systems, and
(iv) the results from the remote database systems are stored in a cache of the system.
